(19) United States
(12) Patent Application Publication
(10) Pub. No.: US 2025/0148721 A1
(43) Pub. Date: May 8, 2025

(54) Elijha Revolution and more

(71) Applicant: Elijha Ammon Bronaugh Watkins, HOUSTON, TX (US)

(72) Inventor: Elijha Ammon Bronaugh Watkins, HOUSTON, TX (US)

(21) Appl. No.: 18/502,603

(22) Filed: Nov. 6, 2023

(51) Int. Cl. G06T 19/00; A43B 1/06; A43B 11/00; G06Q 50/08

(52) U.S. Cl. CPC G06T 19/00; A43B 1/06; A43B 11/00; G06Q 50/08; G06T 2210/16

(57) ABSTRACT

The inventions pioneered by Elijha Ammon Bronaugh Watkins include:
Augmented reality handwritten autographs, fingerprints, birth certificates, and death certificates, integrating AR features with NFTs and blockchain technology for authentication and diverse functionalities.
Augmented reality cups equipped with AR portals, temperature sensors, and interactive features connecting to various e-commerce platforms and healthy living resources.
Eco-friendly building materials like industrial hemp creek and hemp wood for 3D-printed structures, complemented by sustainable glass production methods.
A visionary eco-technology space, Elijha Revolution, powered entirely by solar energy, offering immersive experiences such as AR/VR galleries, studios, gyms, and more.
Inventive products like augmented reality lollipops, pet tags, babysitting bibs, domino sets, putty, prosthetic shoes, vendor machines, and solar-powered plant vases, each embedding AR/VR/XR features for enhanced functionalities and experiences.
Innovative applications of AR/VR in education, entertainment, clothing, films, photos, party supplies, and beyond, revolutionizing how we interact with technology and the world around us.

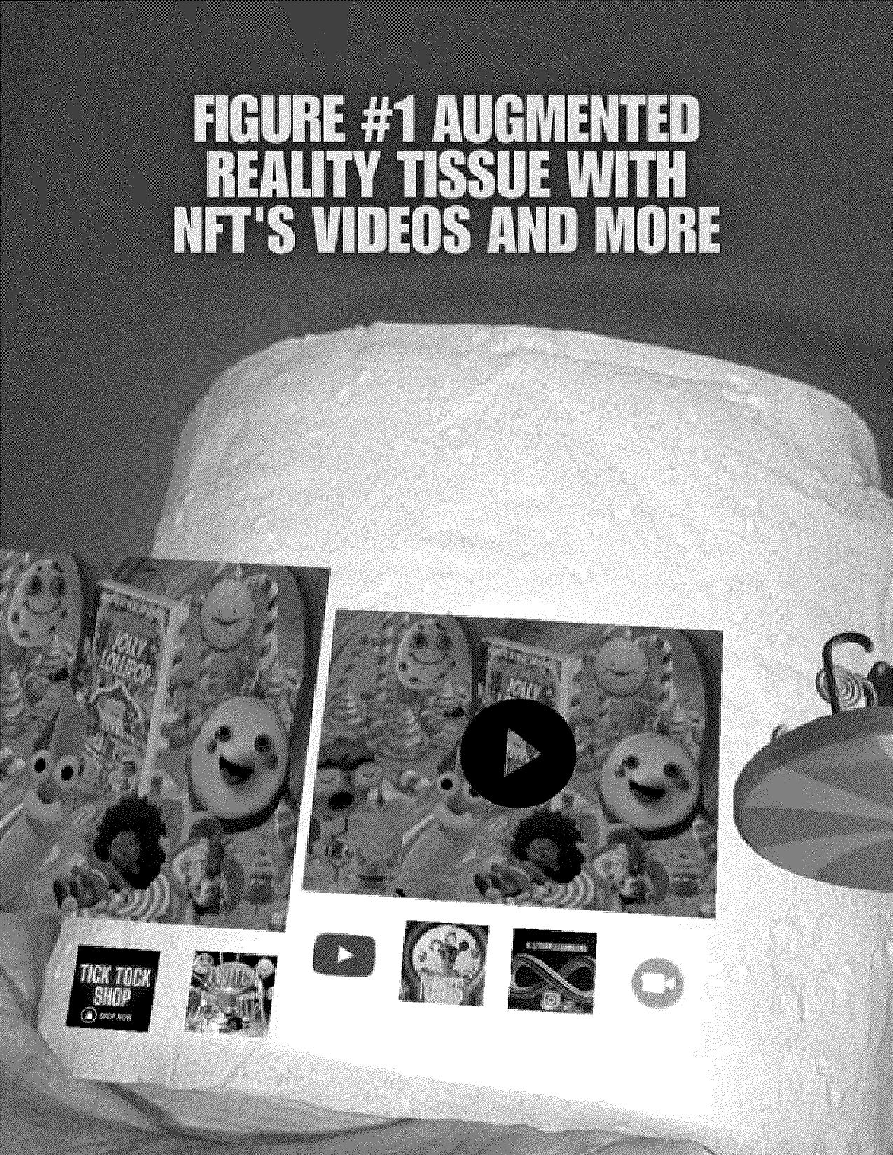

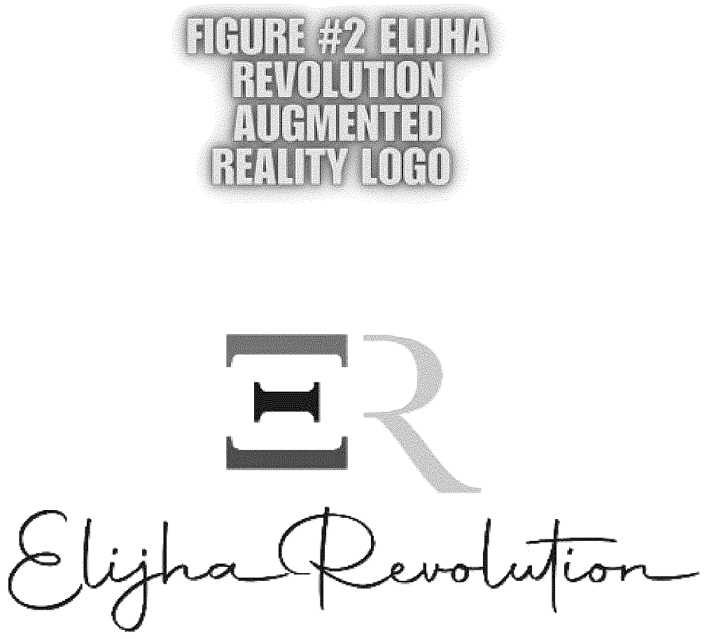

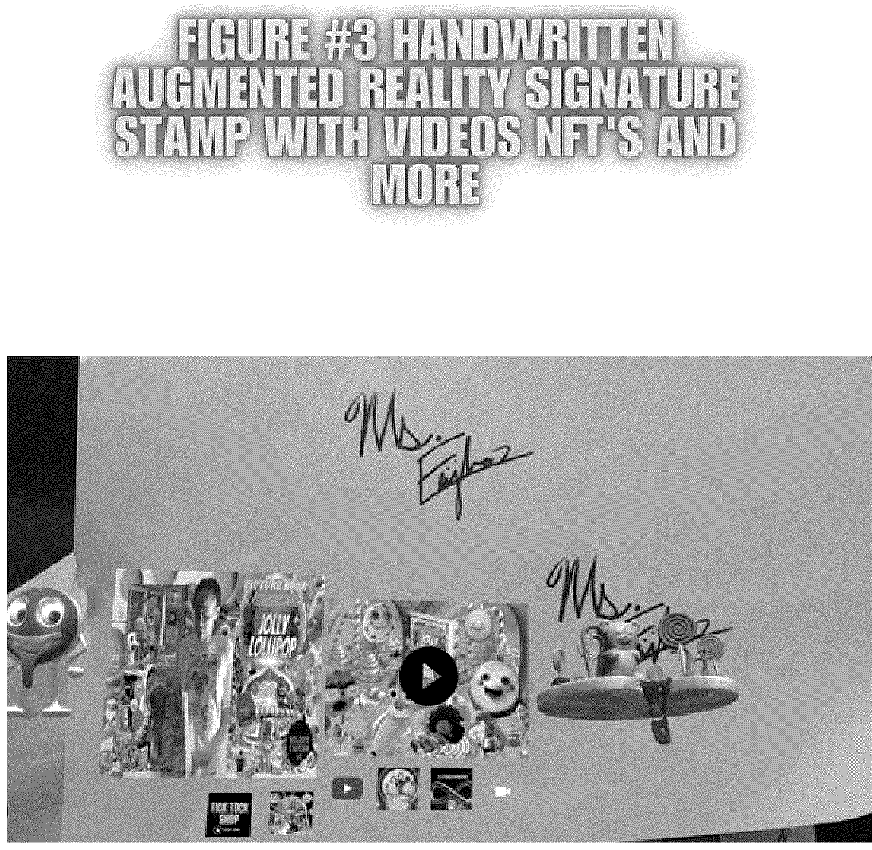

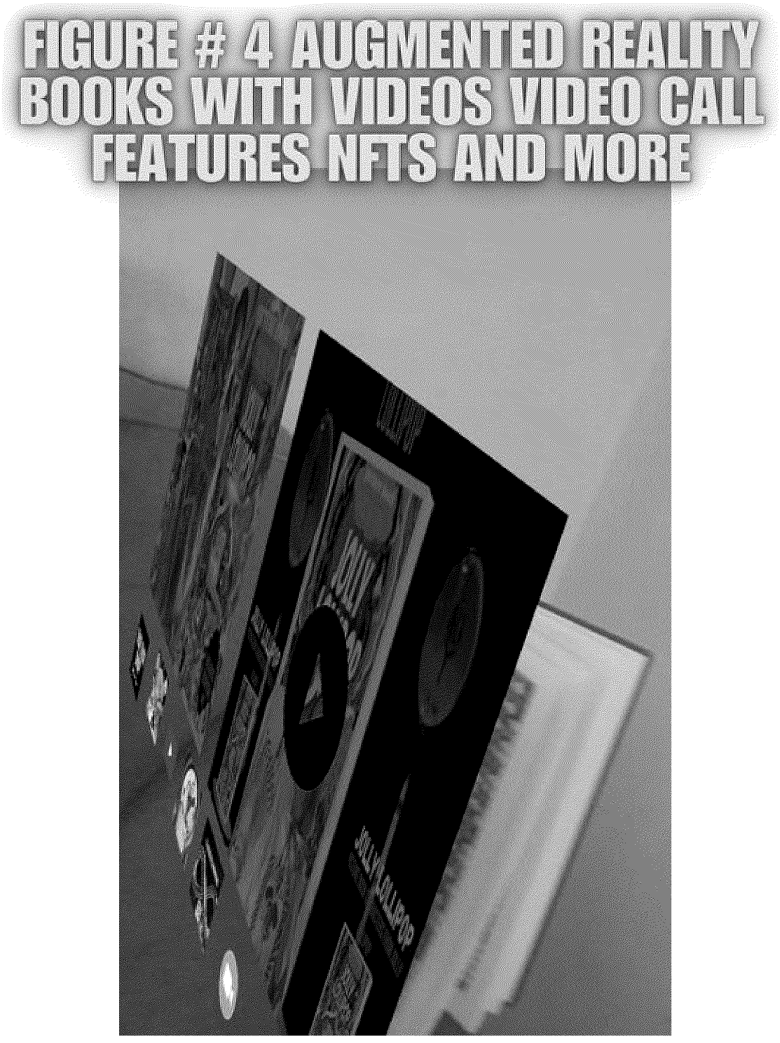

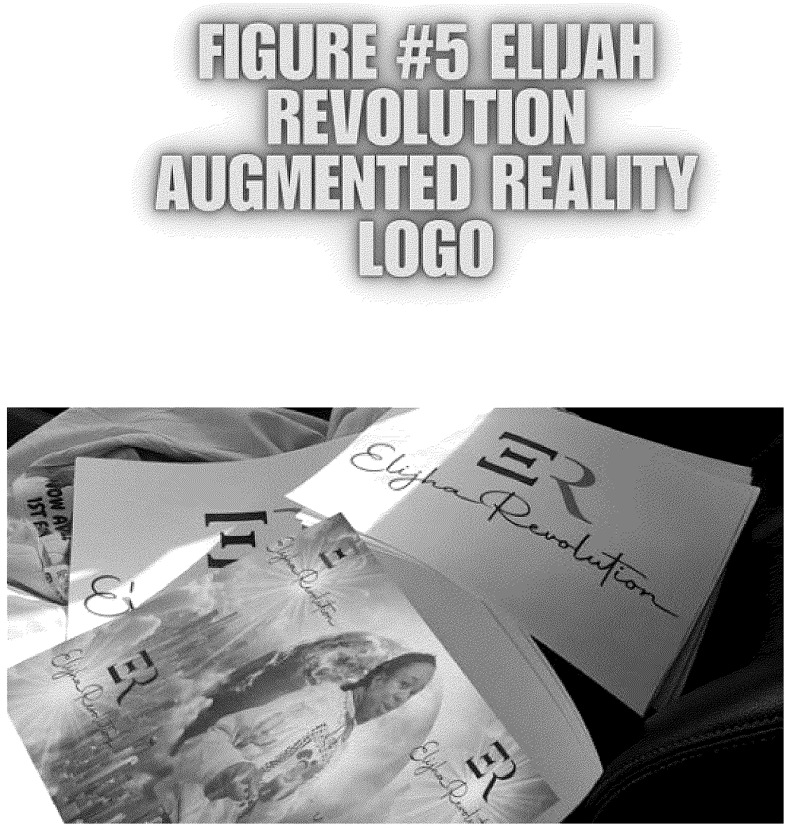

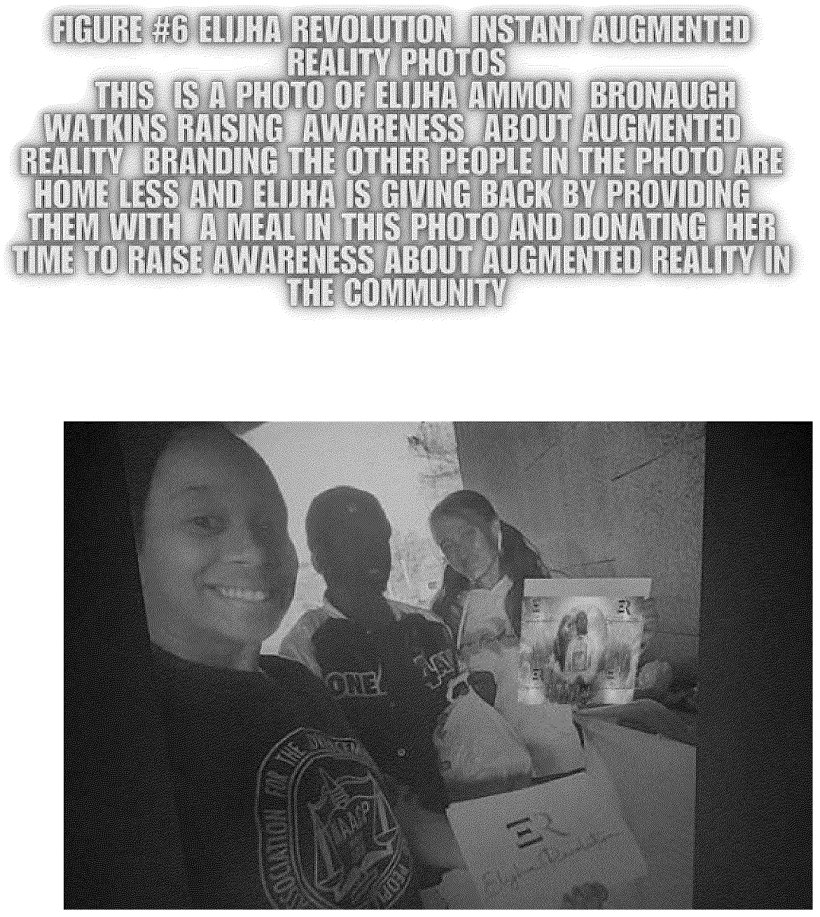

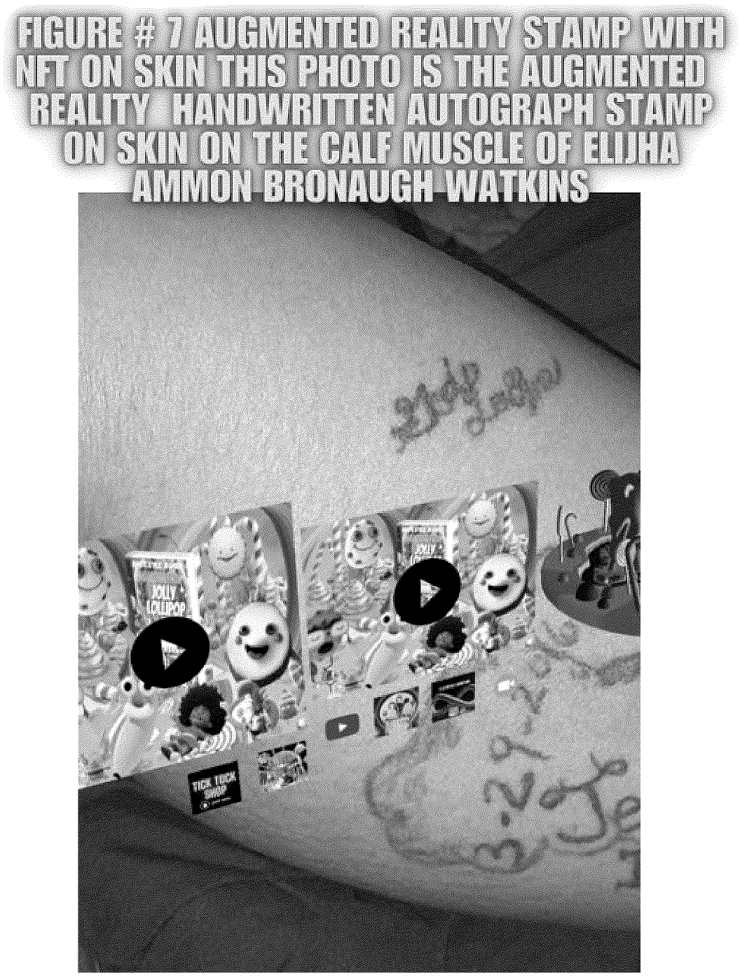

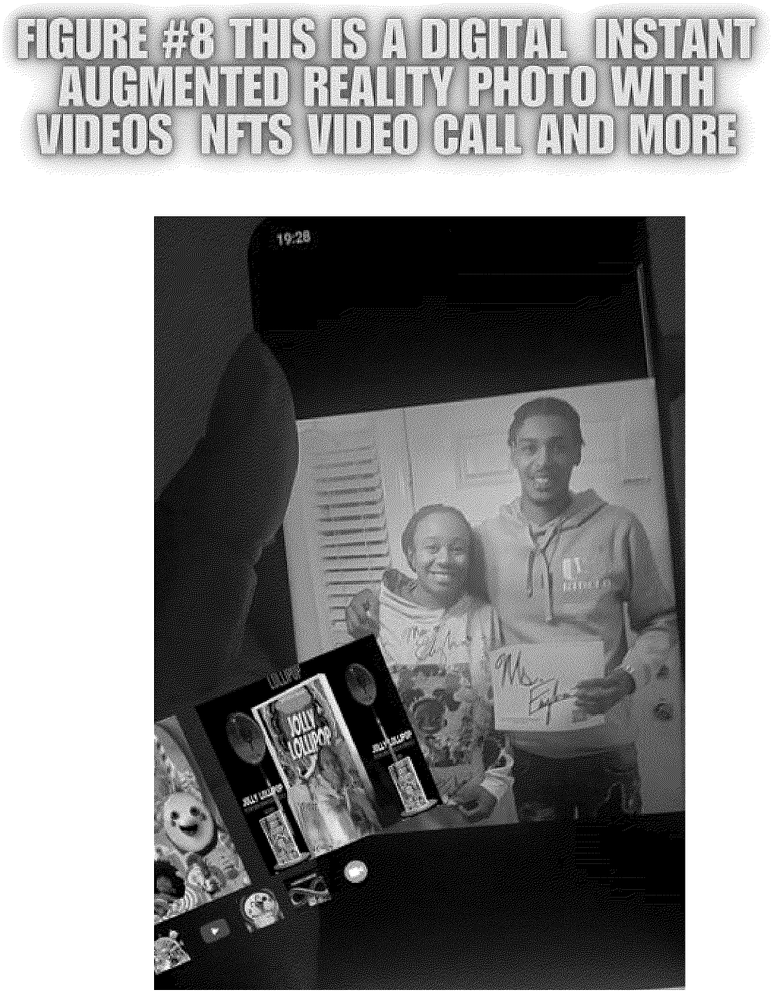

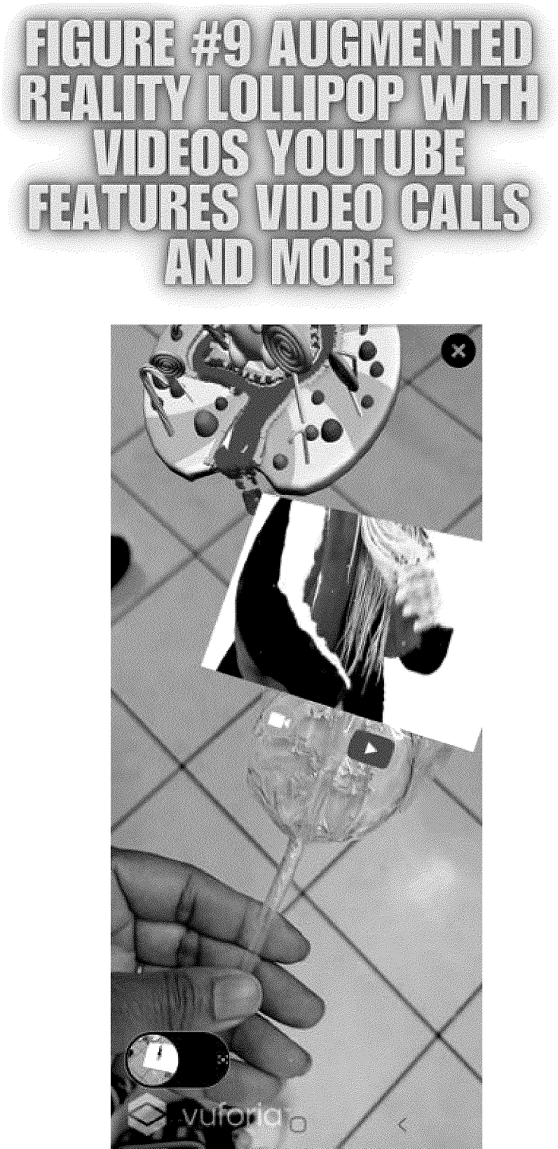

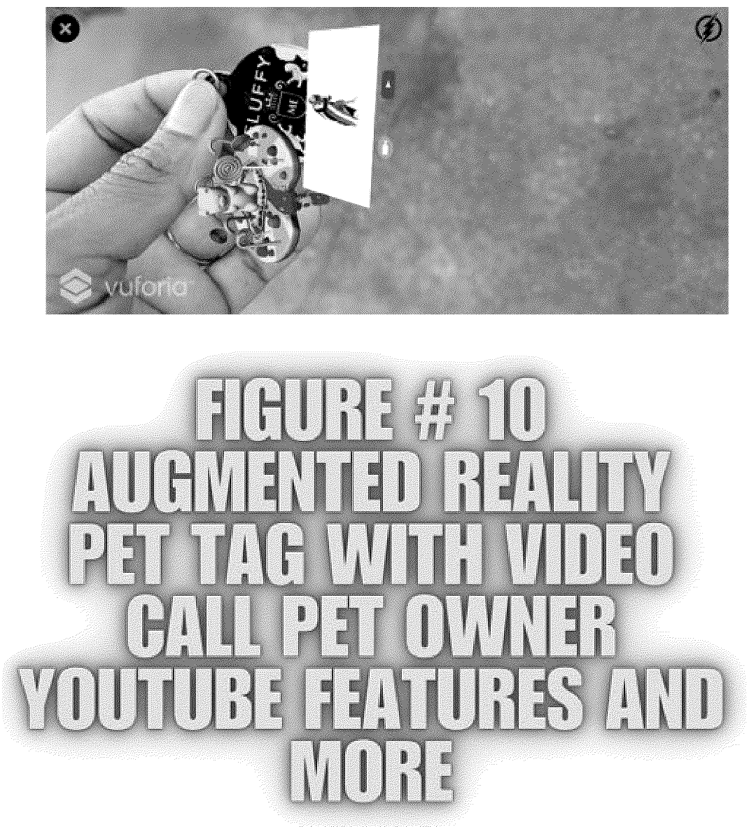

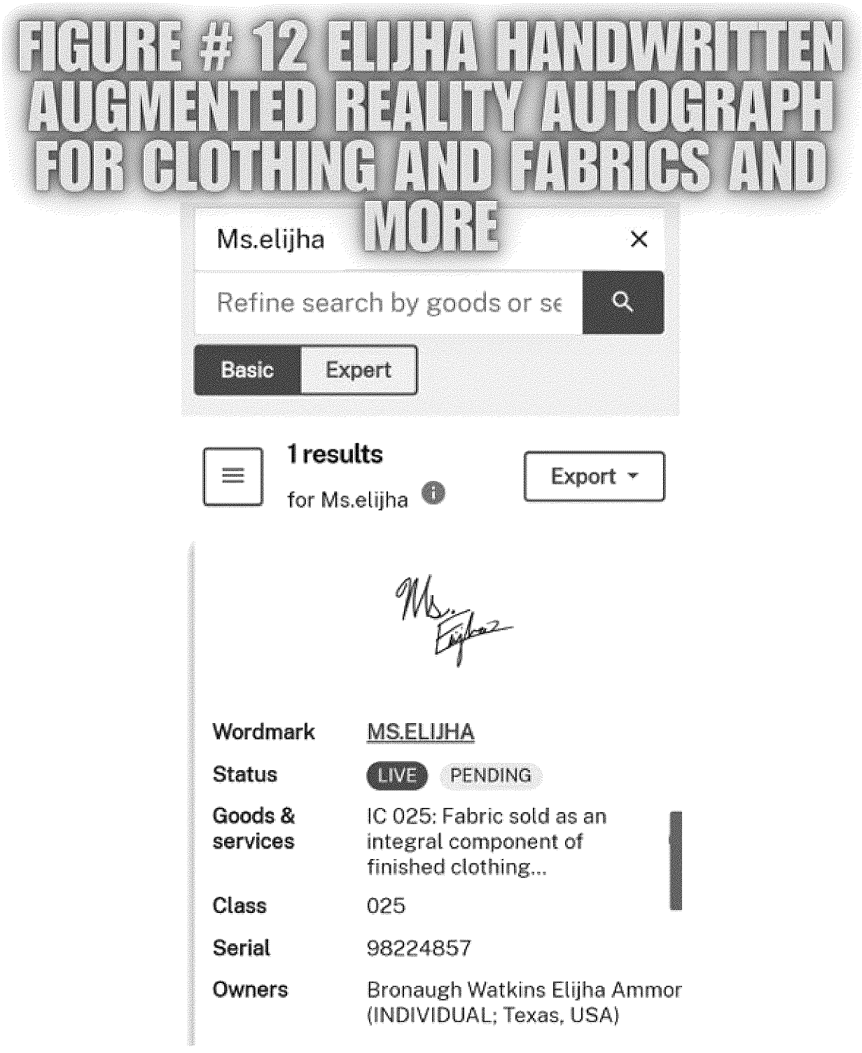

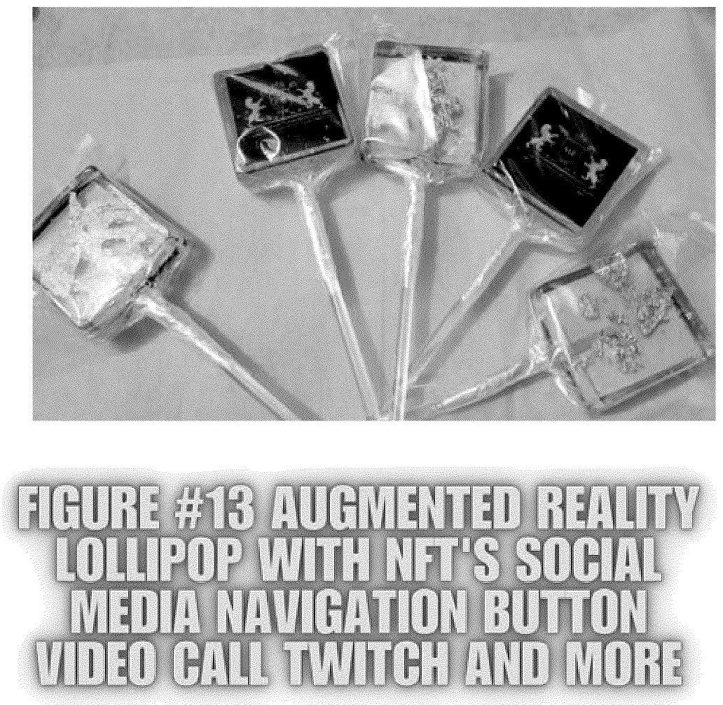

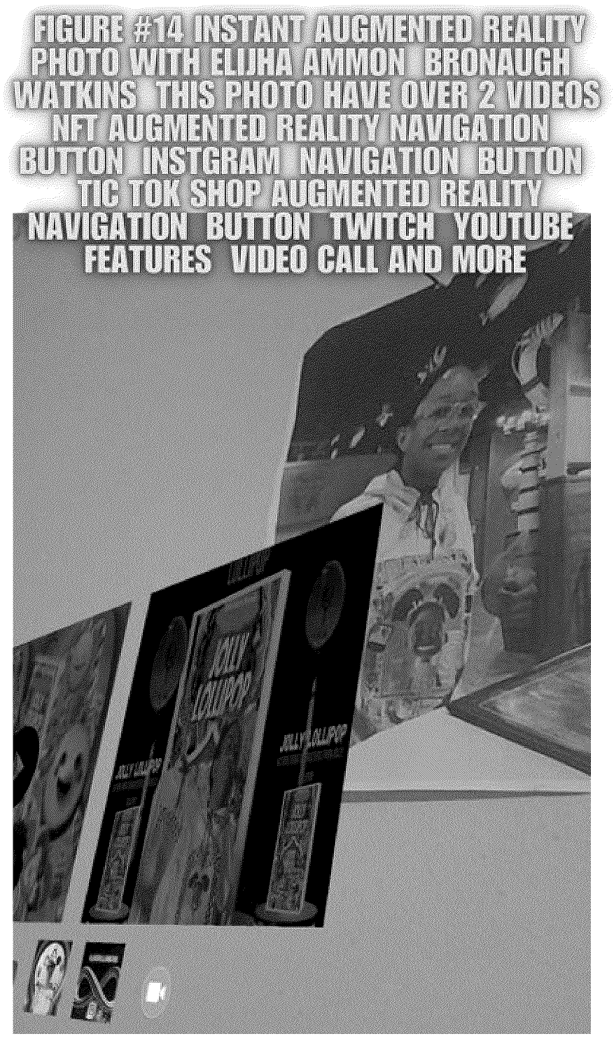

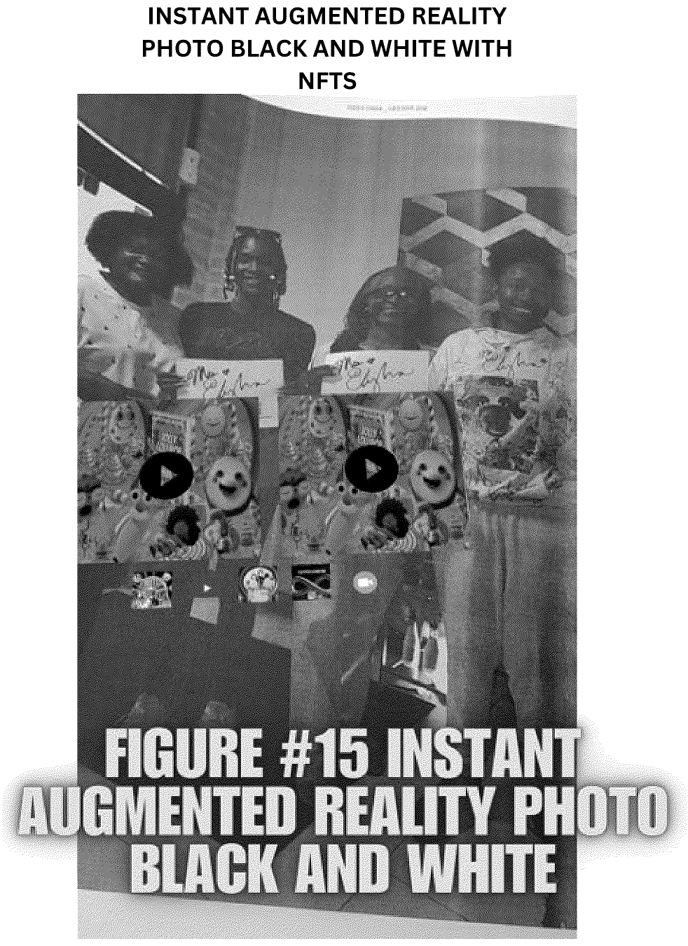

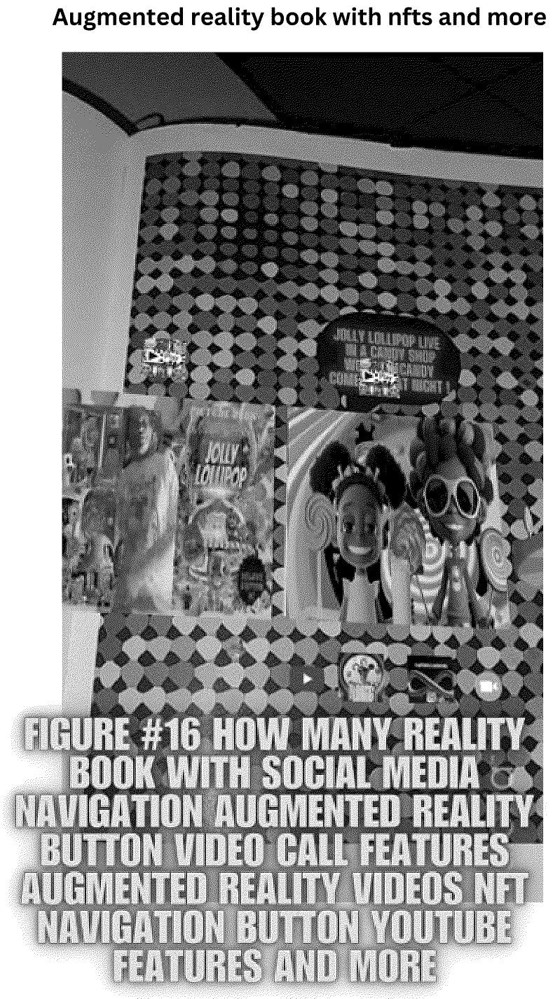

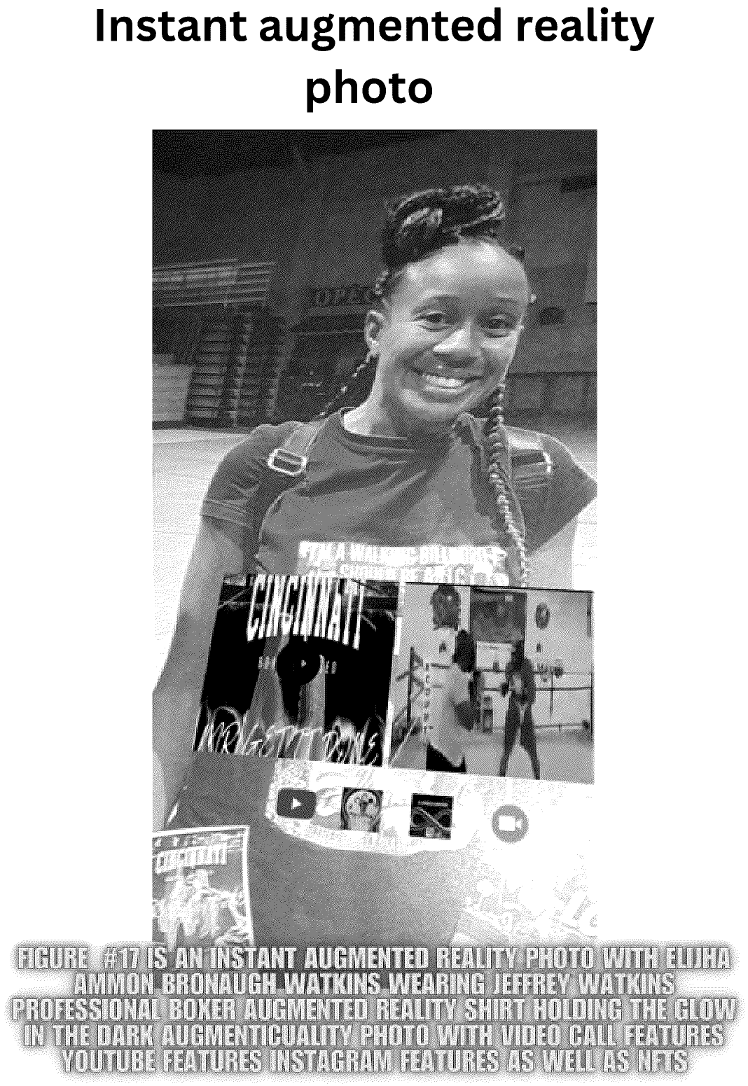

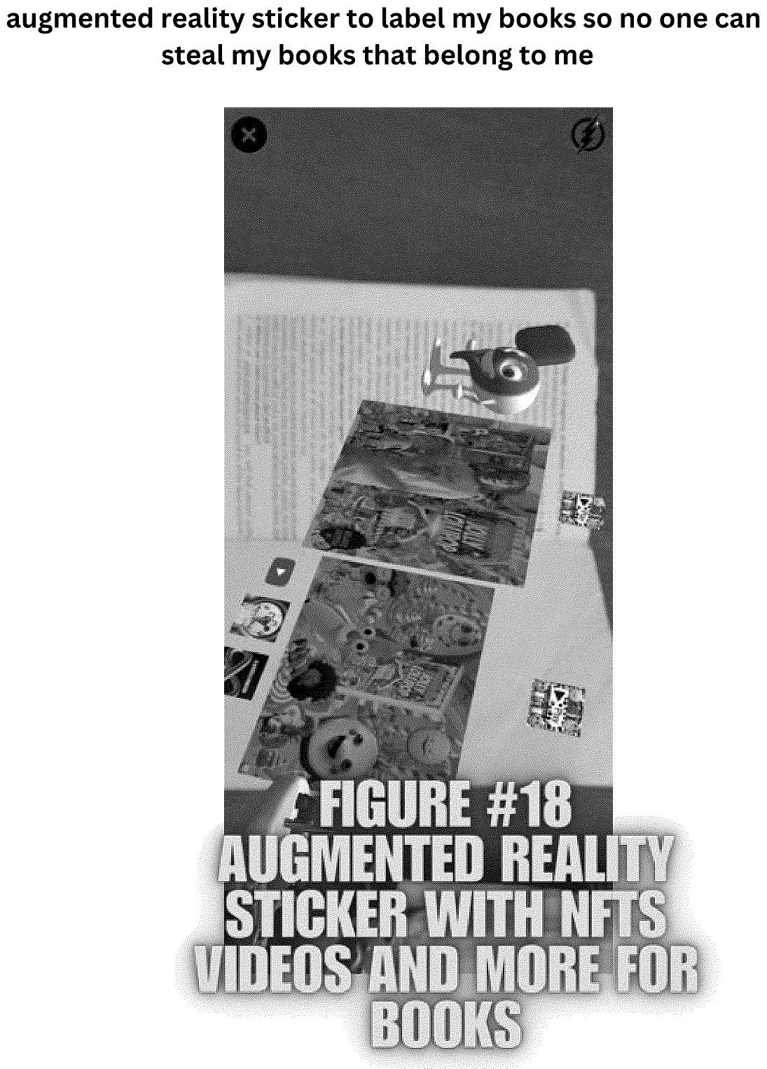

FIG. 1: Biometric Handwritten Augmented Reality Autograph/Signature Stamp System, comprising:
A physical paper autograph encoded with biometric data and identity information.
Augmented reality features including videos, NFTs, e-commerce store features, games, and more.
Encryption for securing the autograph's content and identity information.
Integration with online and offline experiences.
A stamp associated with the original person only for verification purposes.

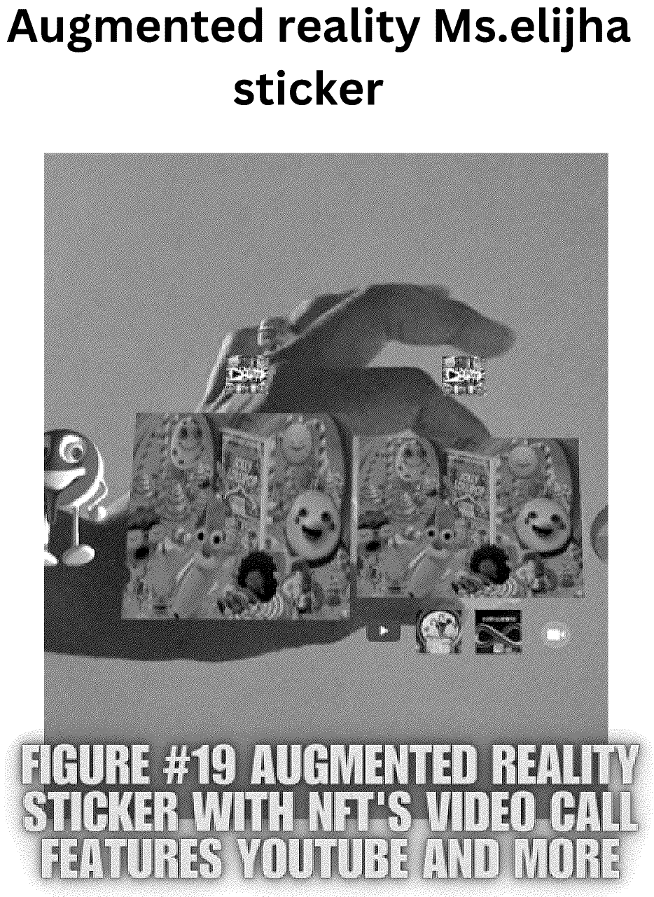

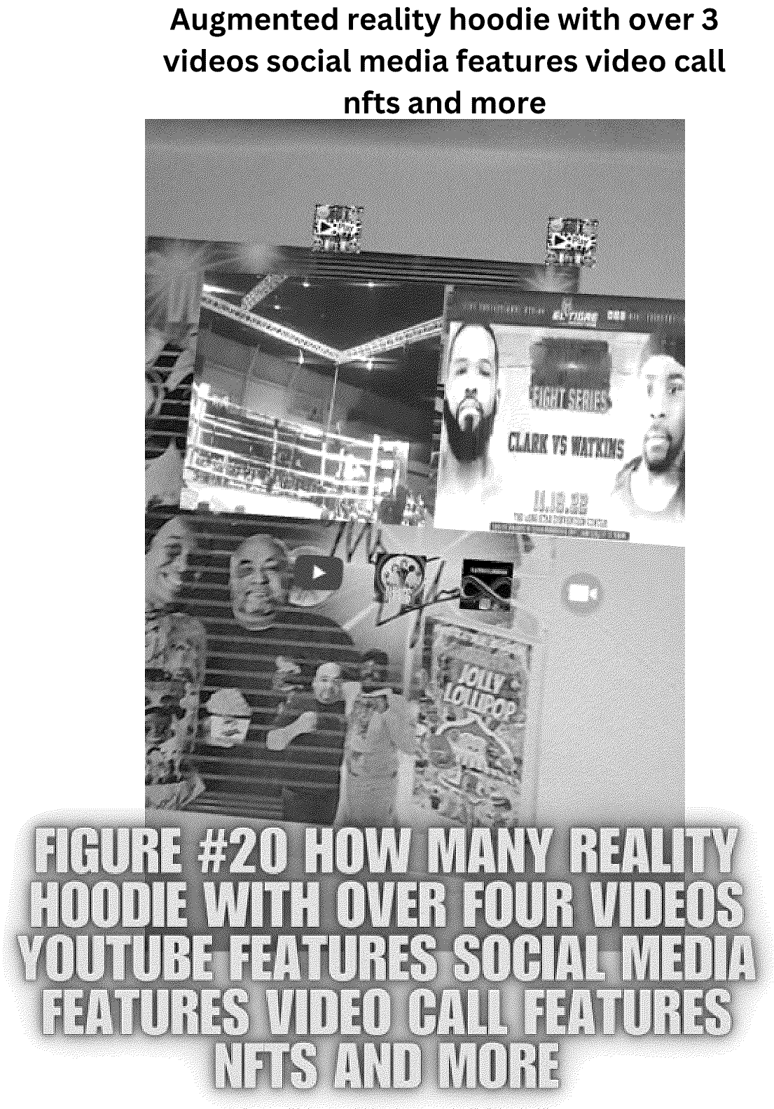

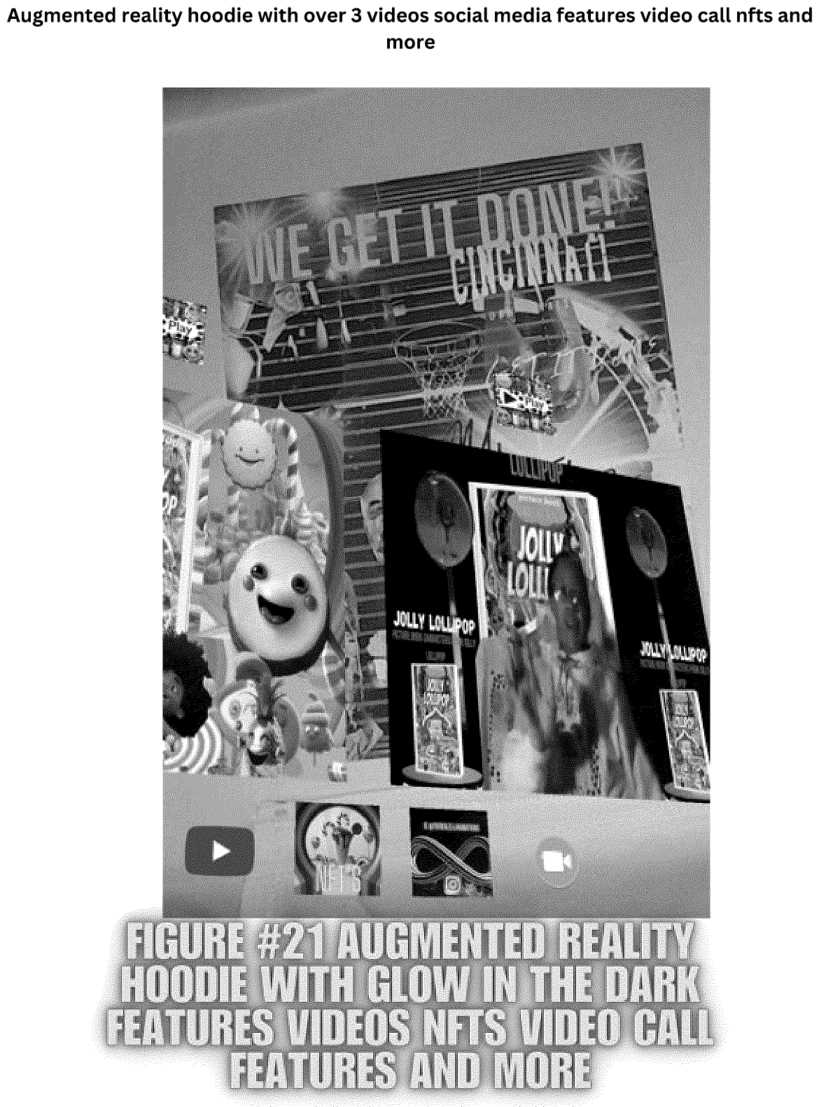

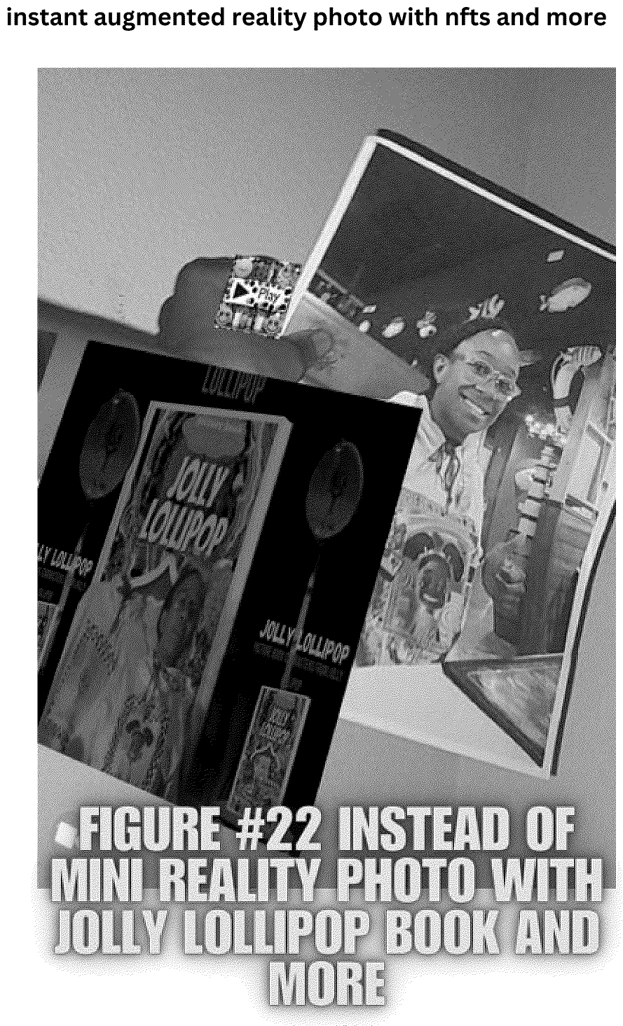

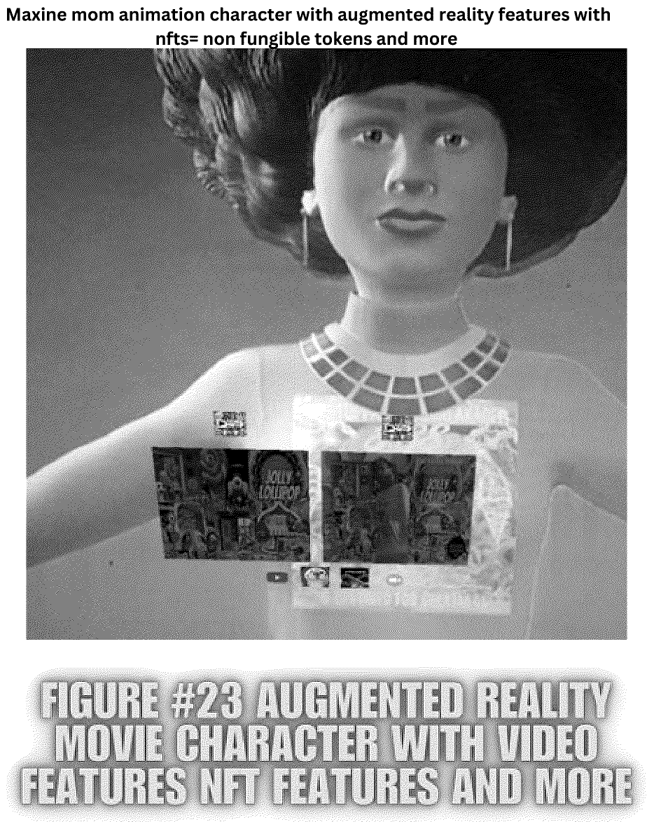

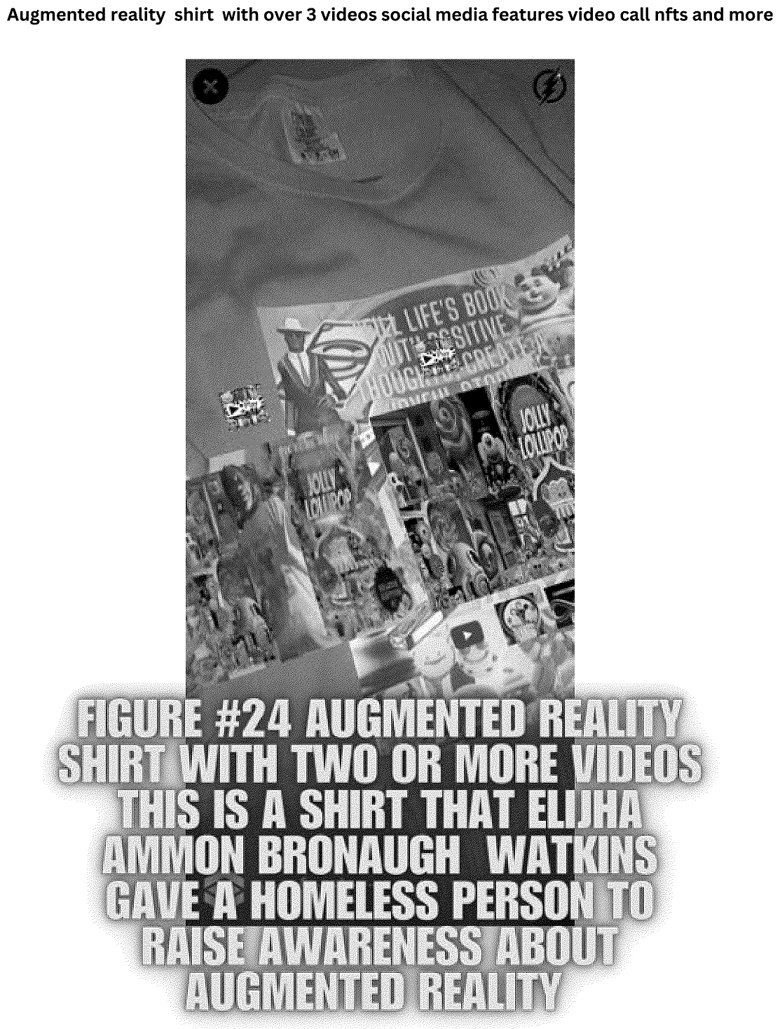

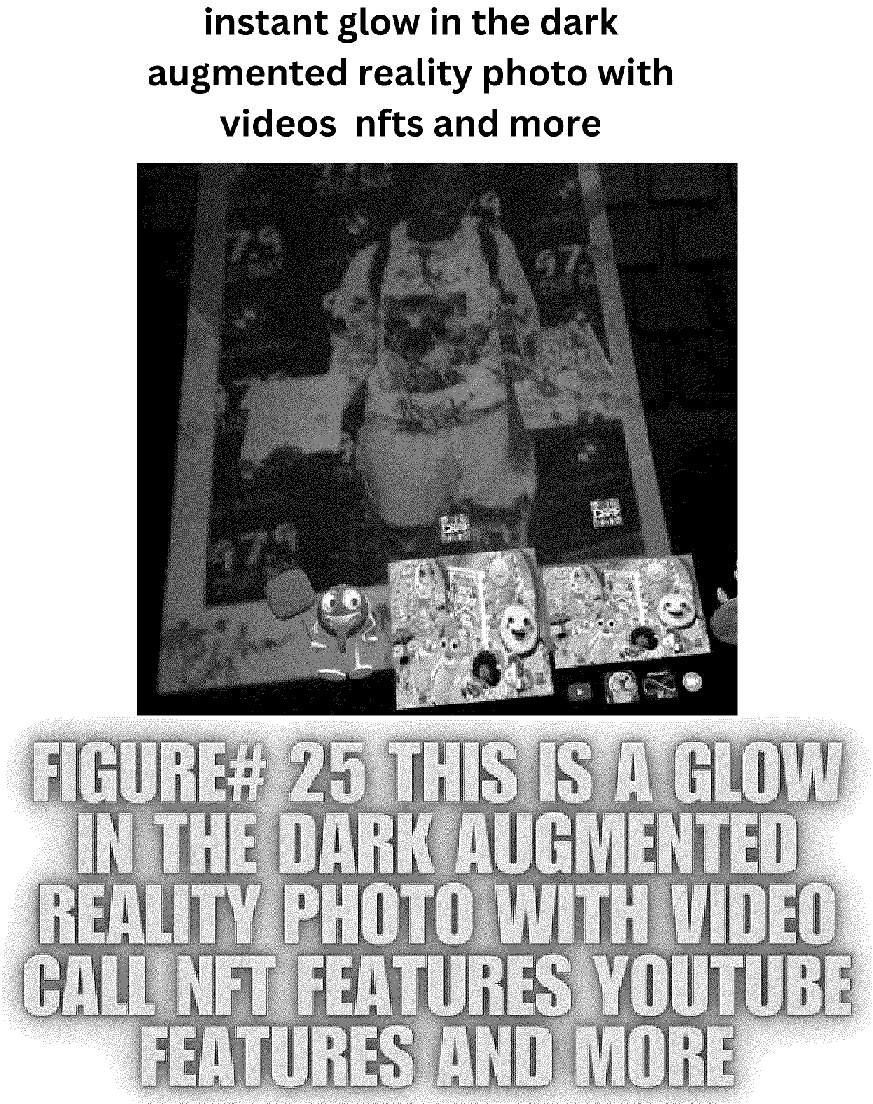

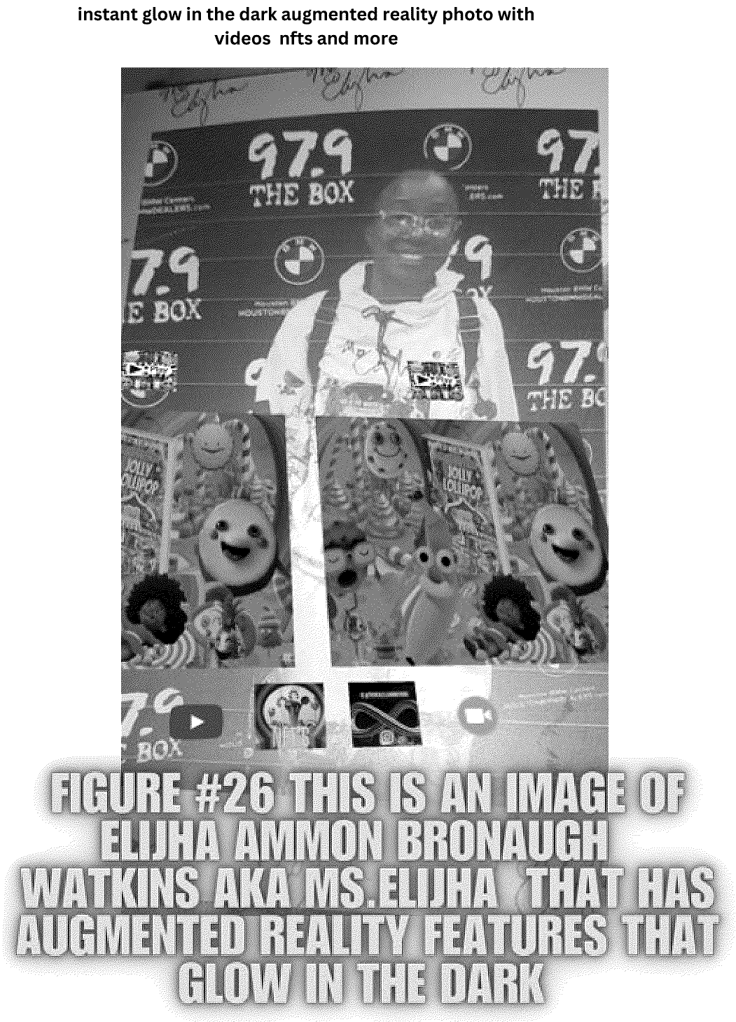

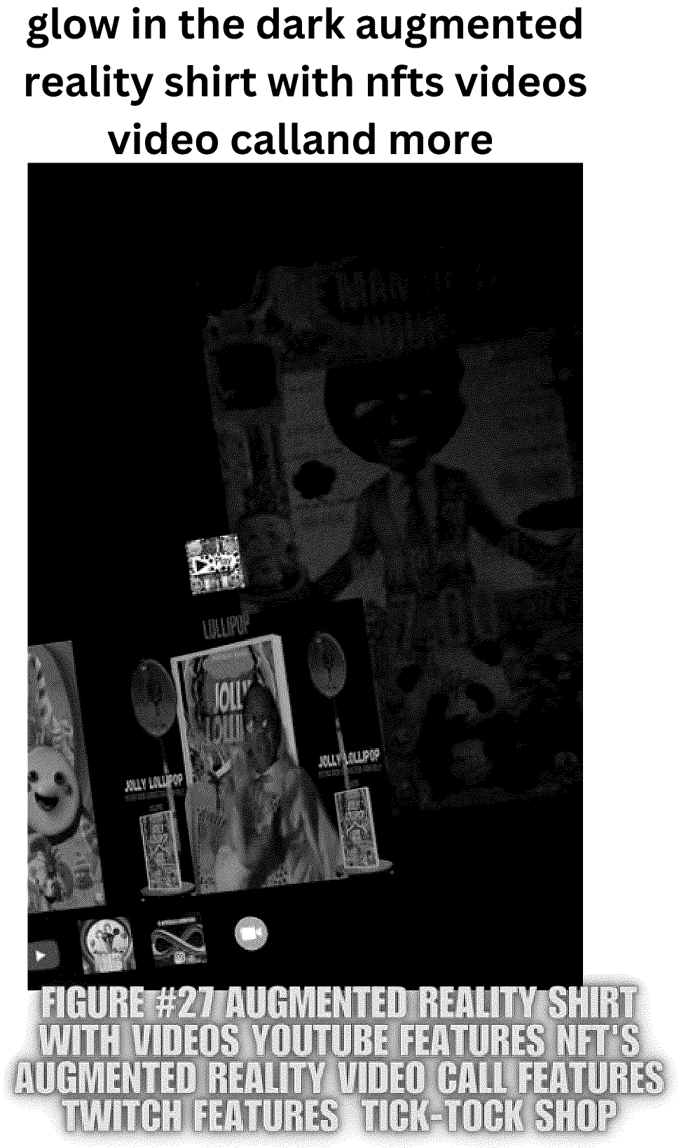

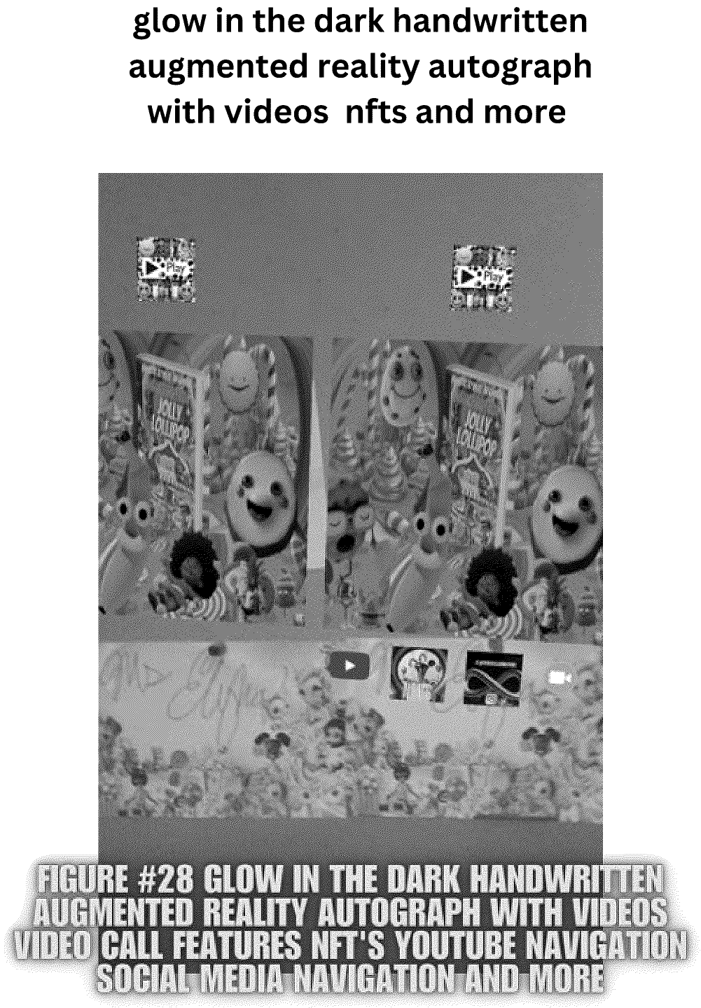

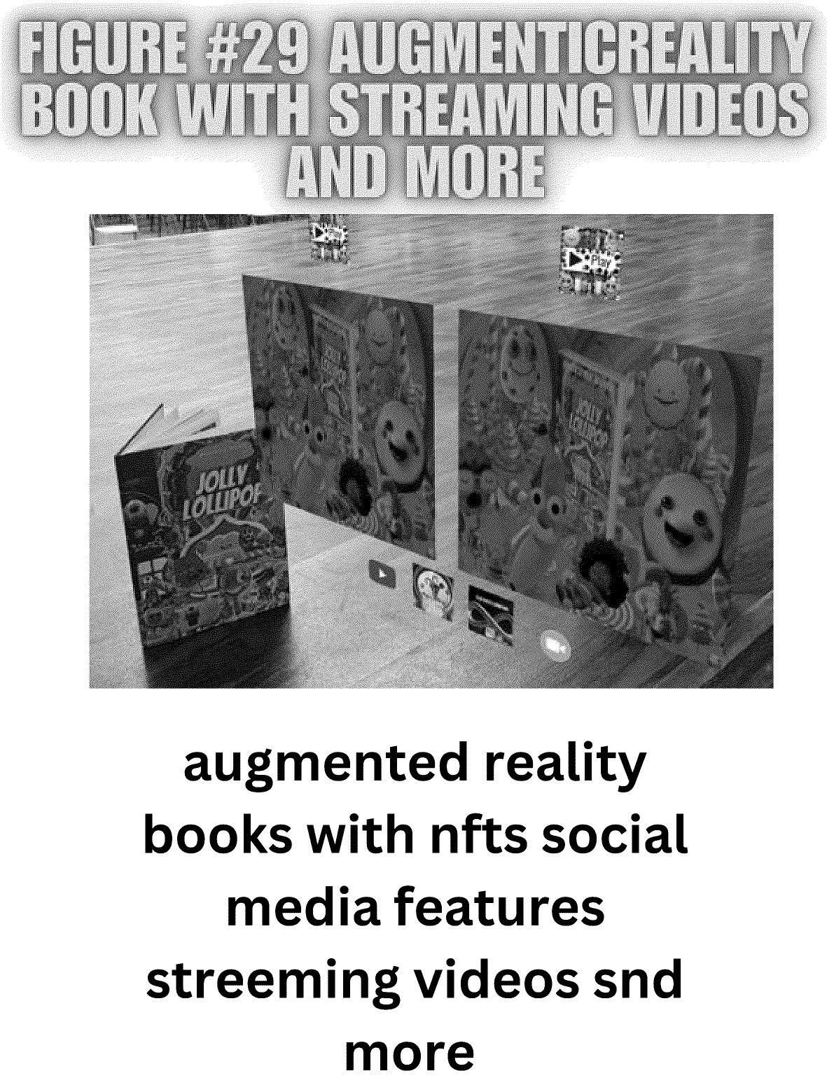

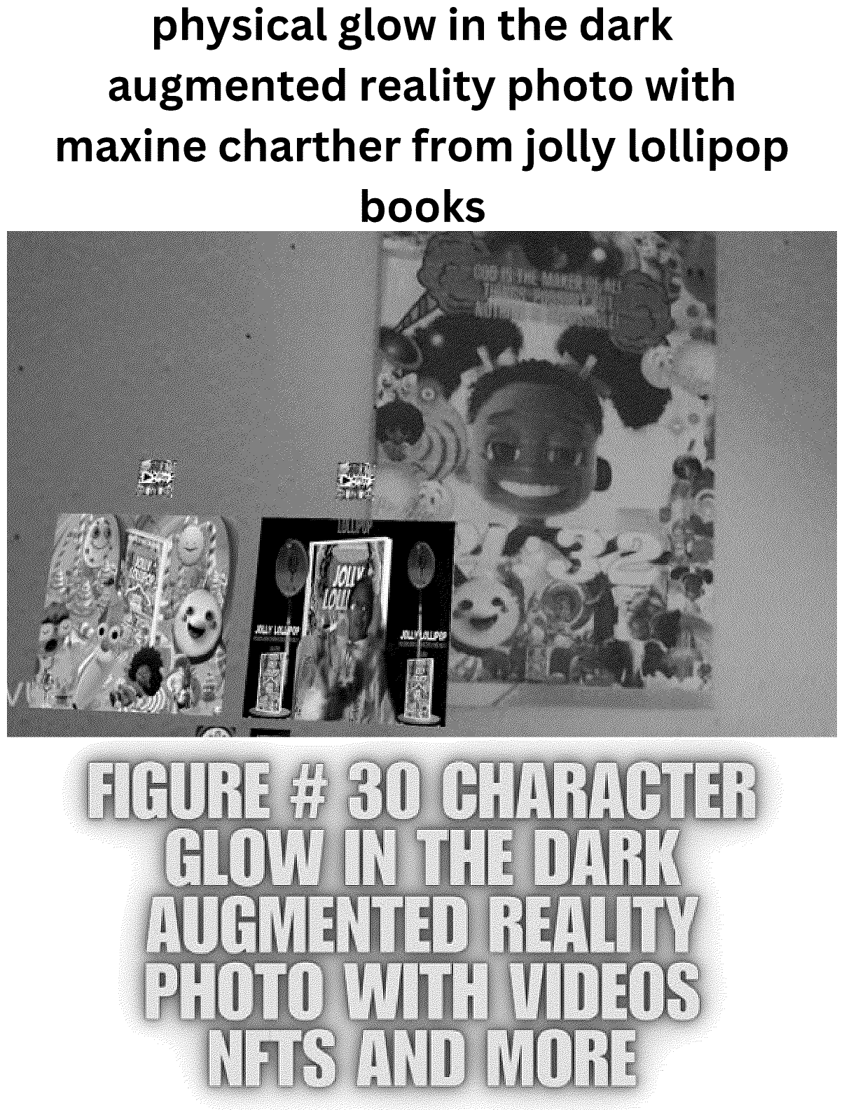

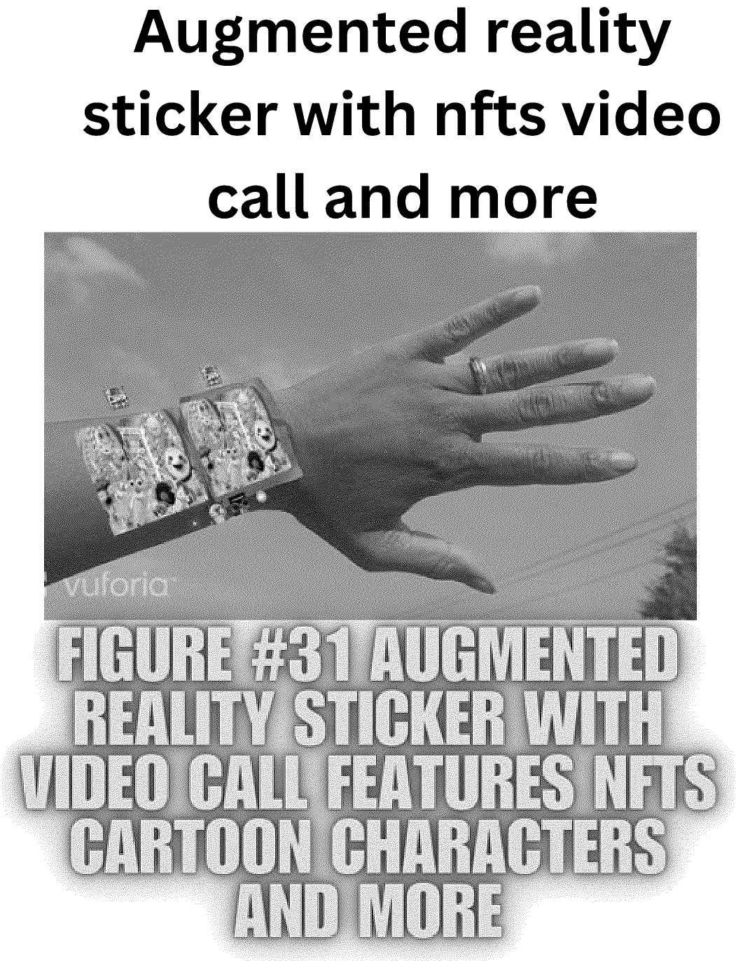

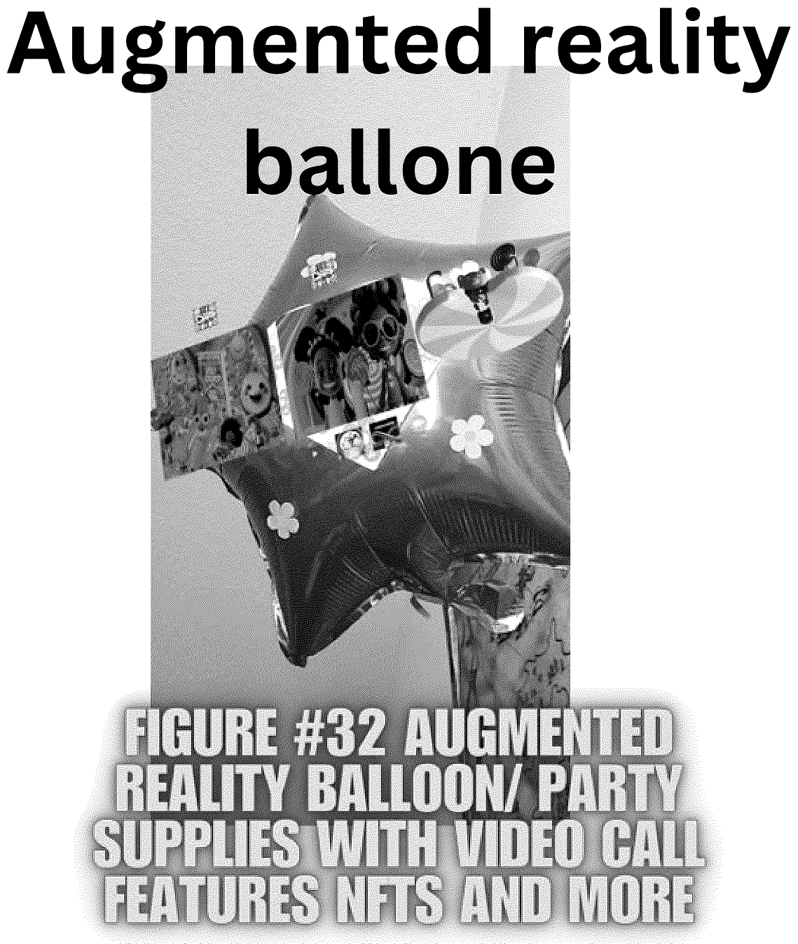

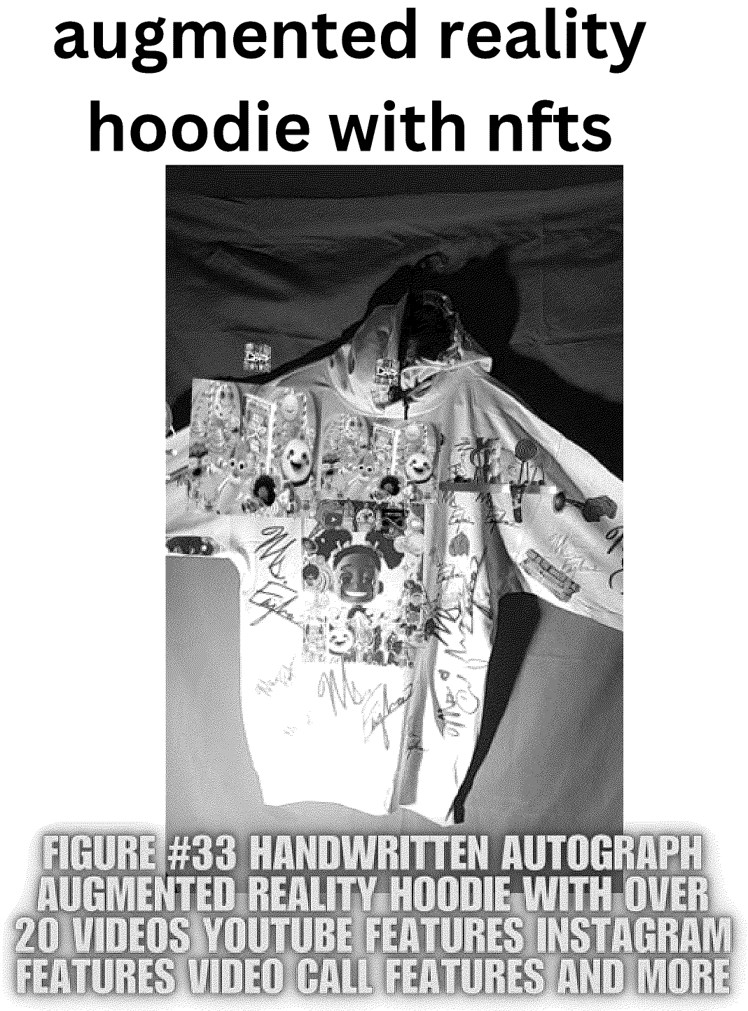

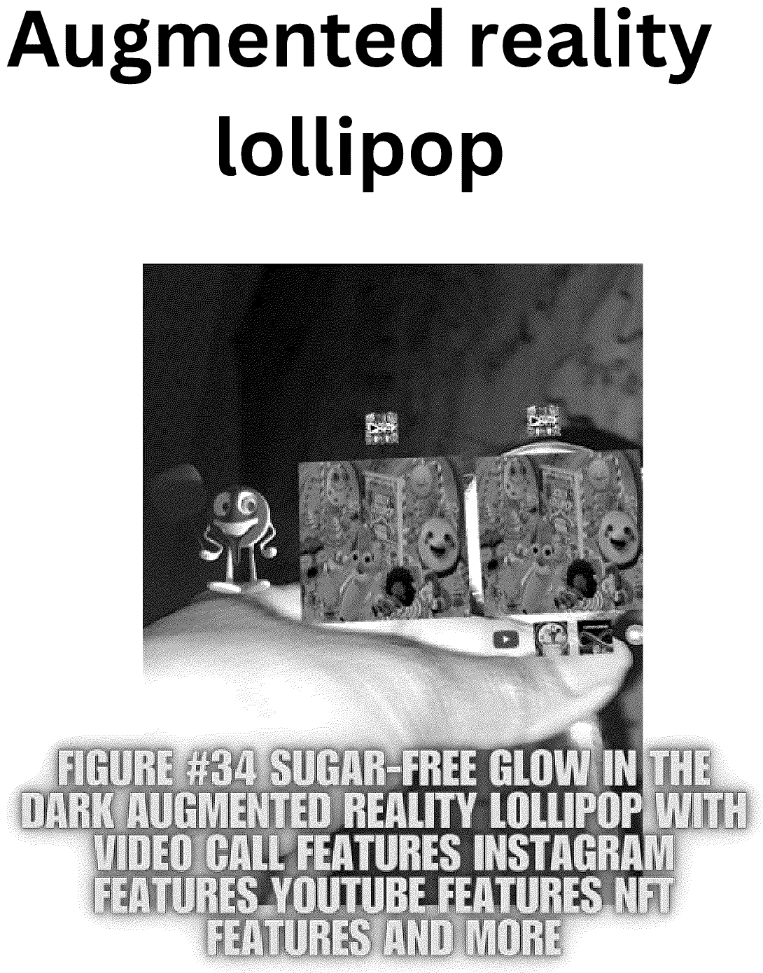

FIG. 2: Instant Augmented Reality Photo System with NFTs and more, comprising:
Physical and tangible products such as books, puzzles, and apparel.
Augmented reality features including videos, NFTs, e-commerce store features, games, and video calling.
Encryption for securing the photo's content.
Integration with the Web3 domain for ownership and control of NFTs.

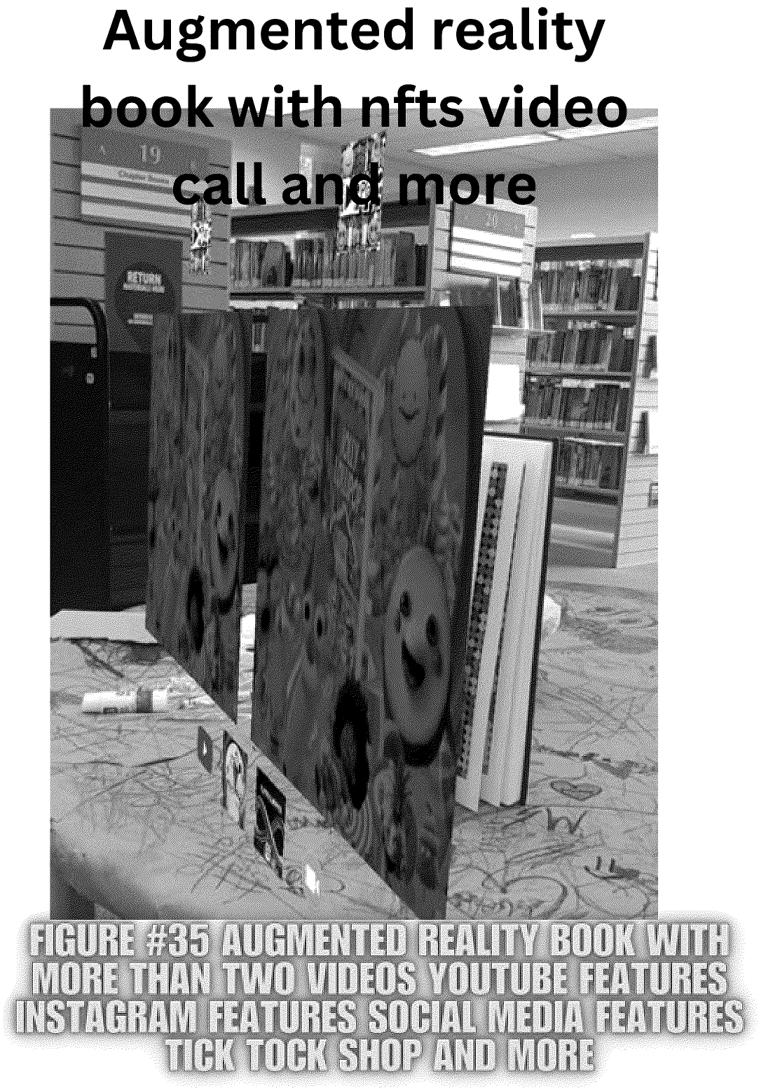

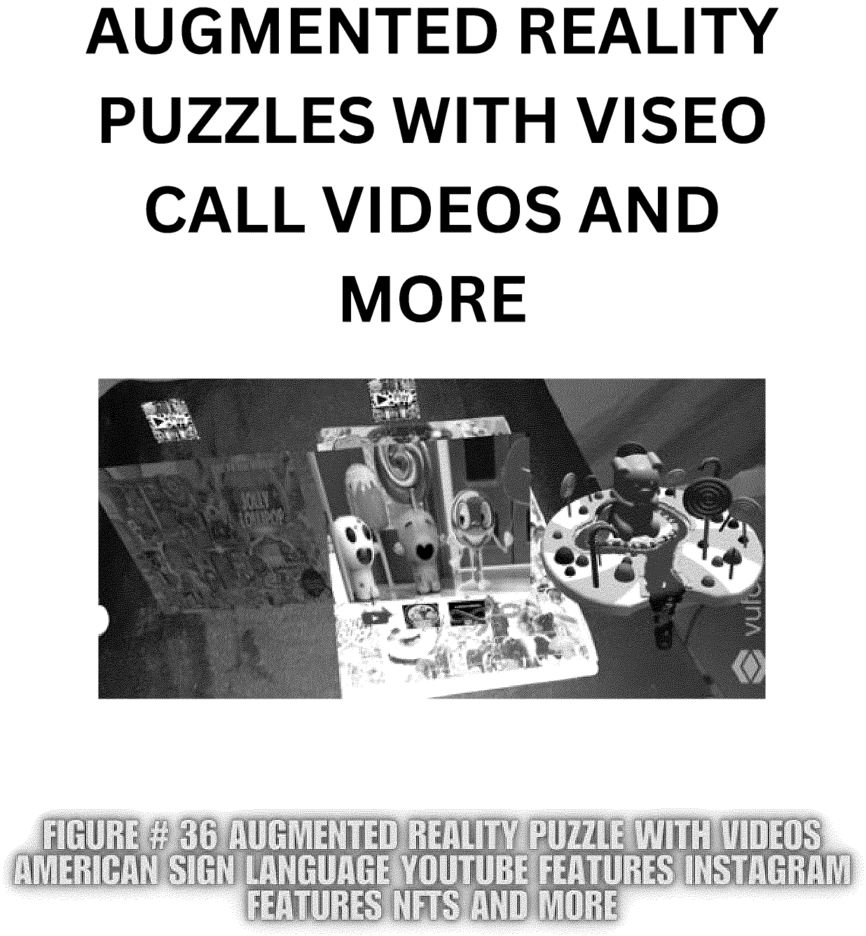

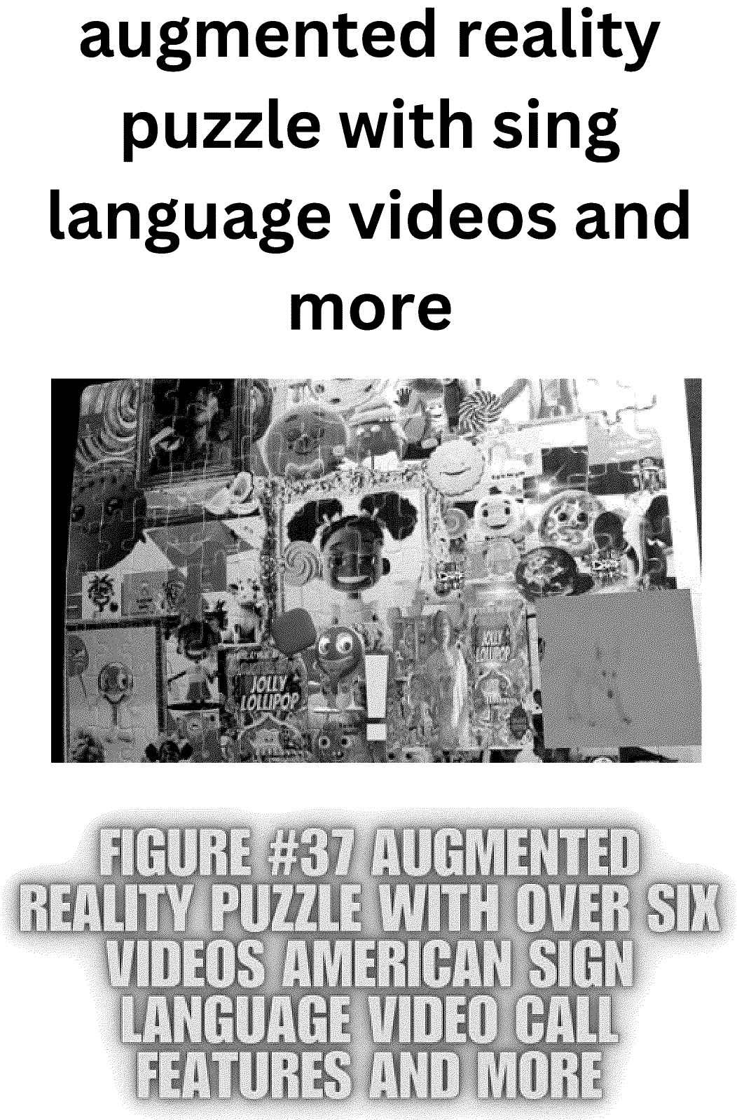

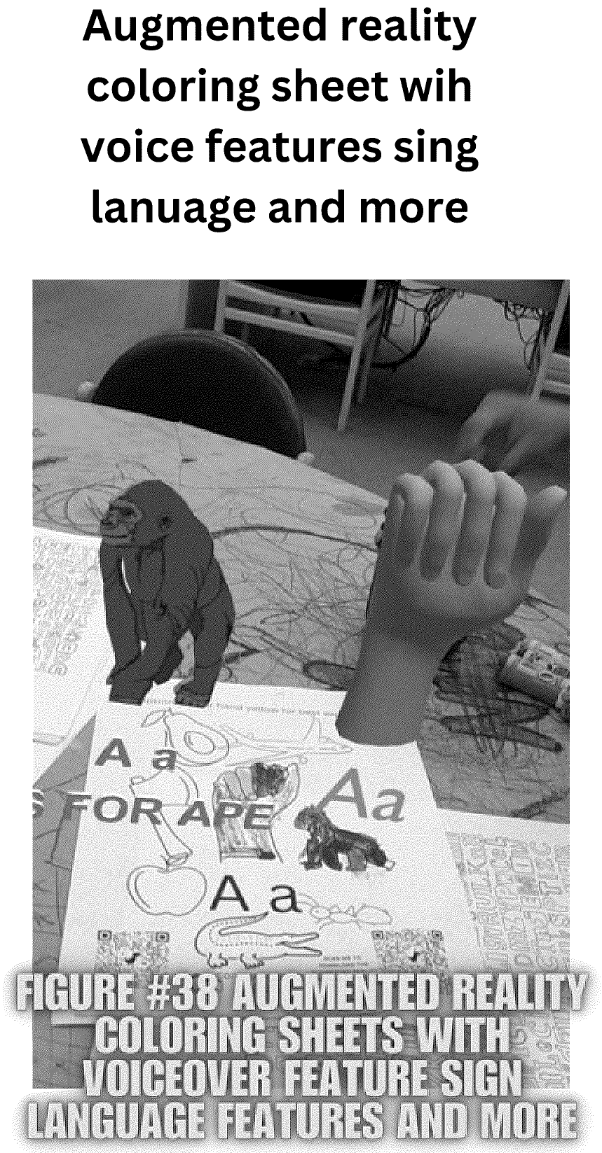

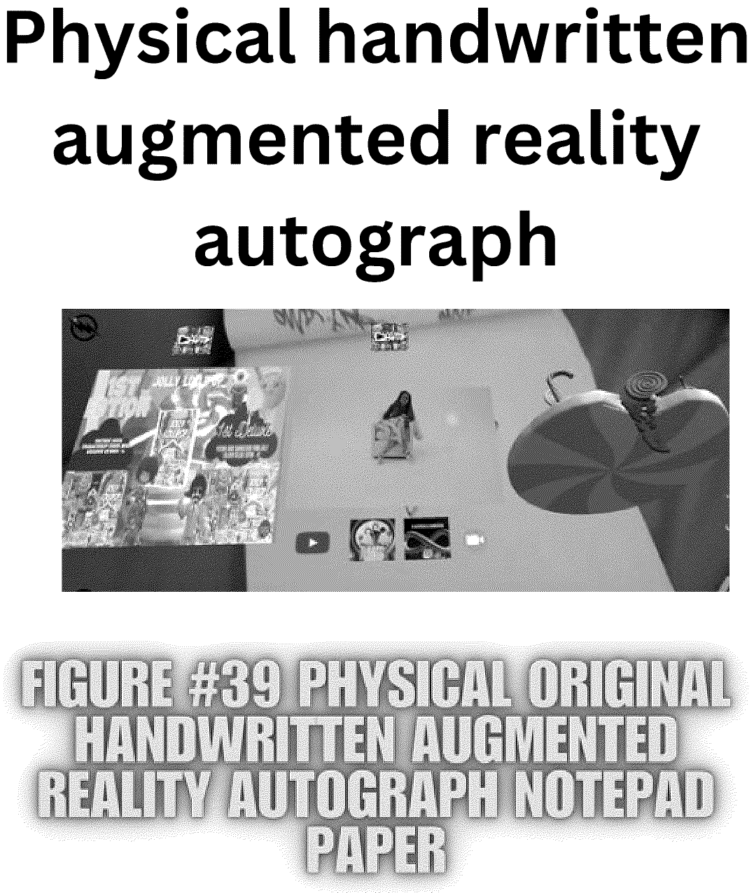

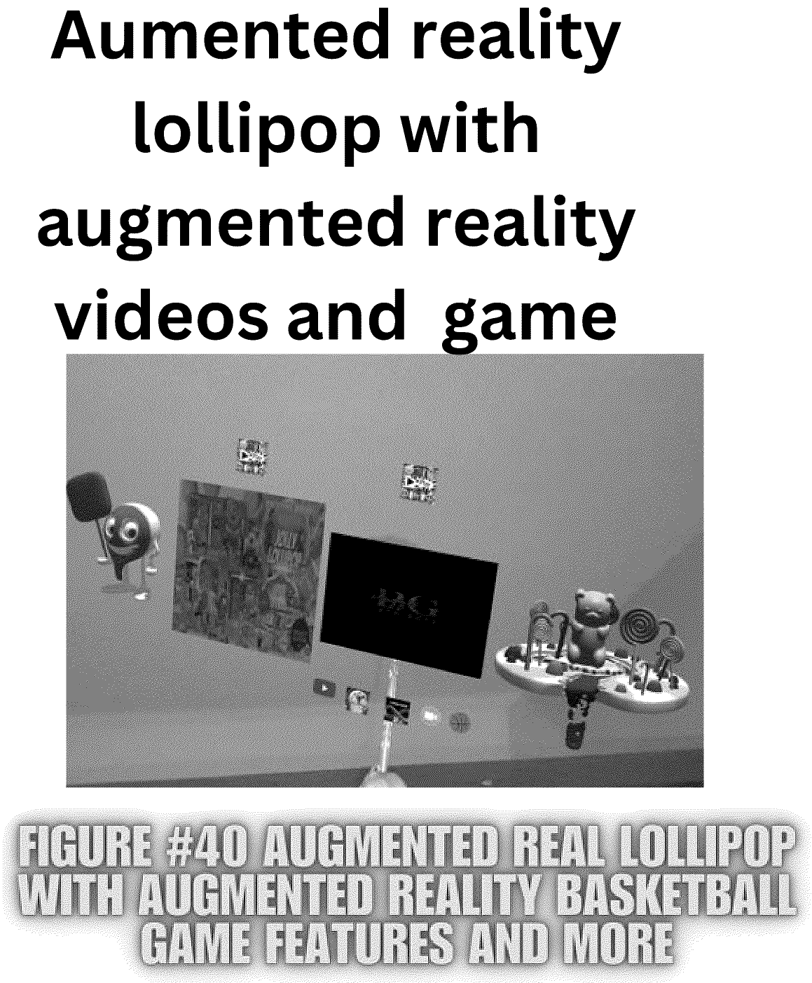

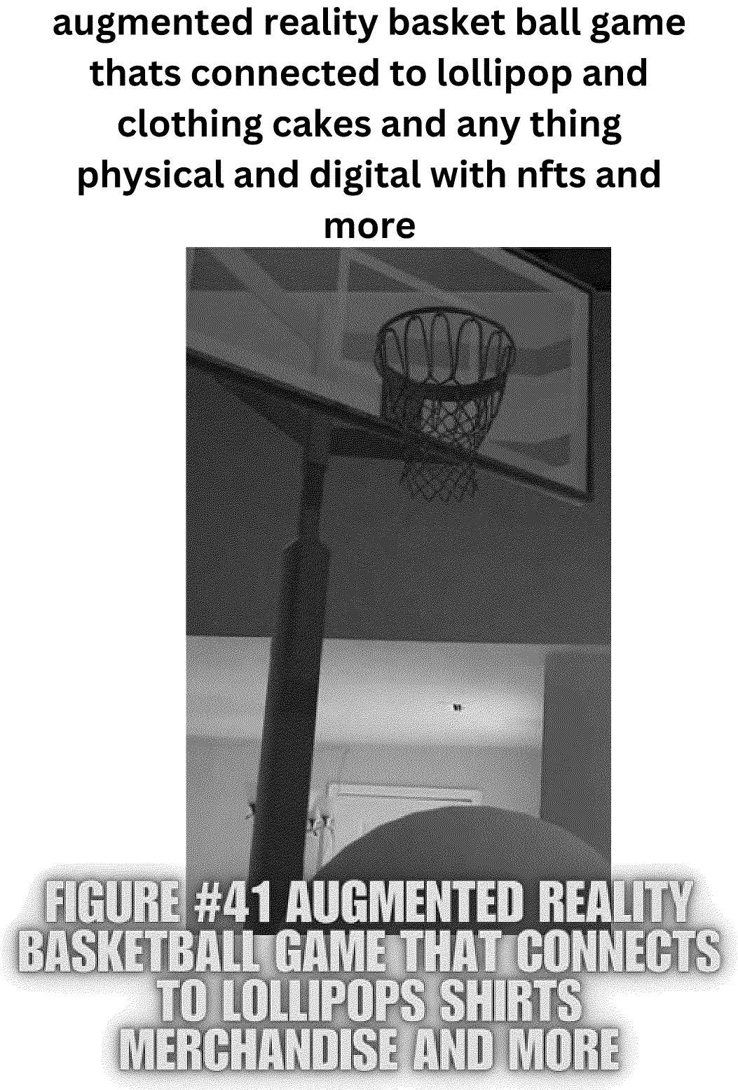

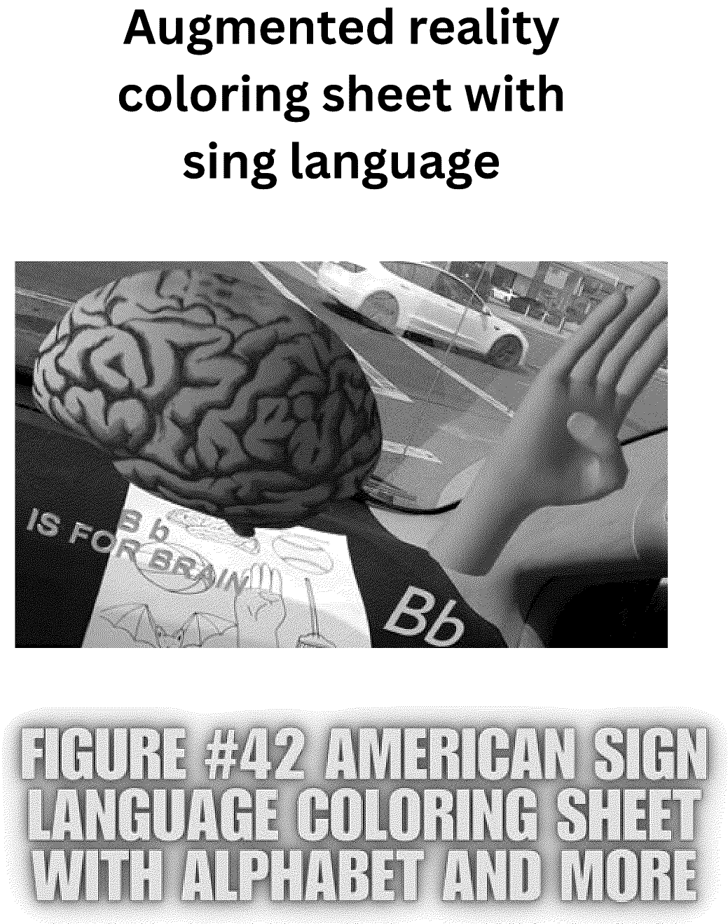

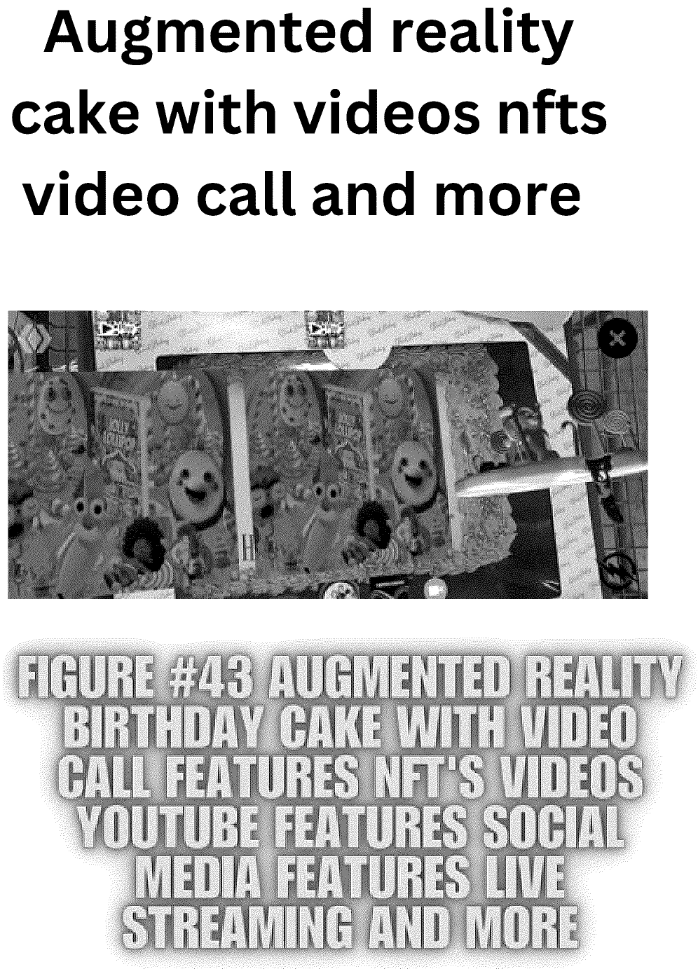

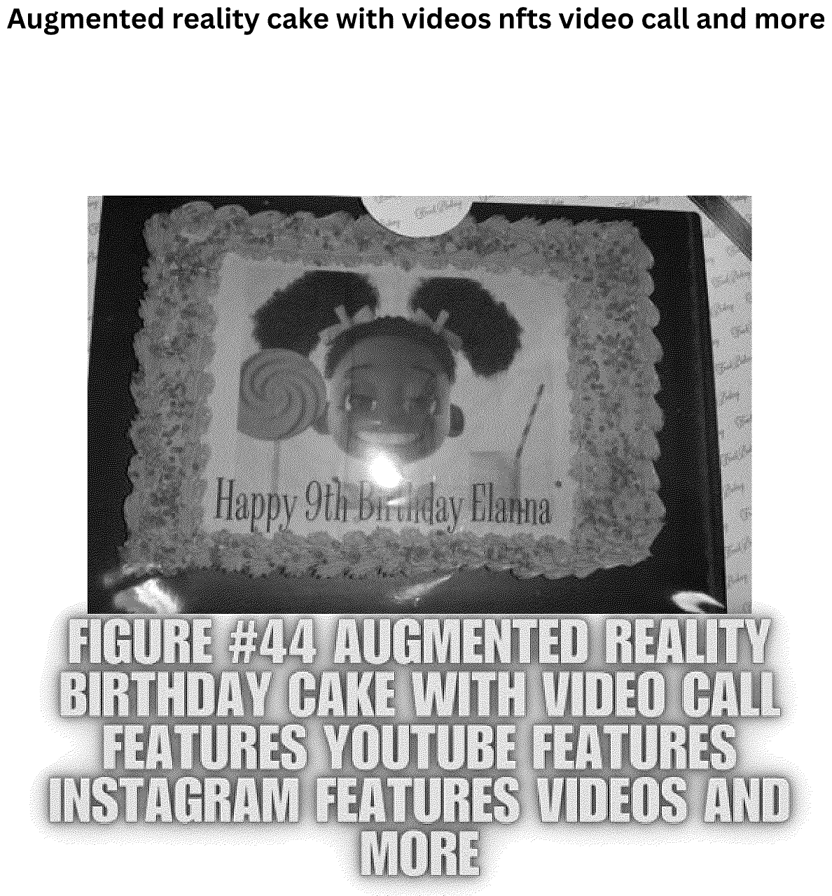

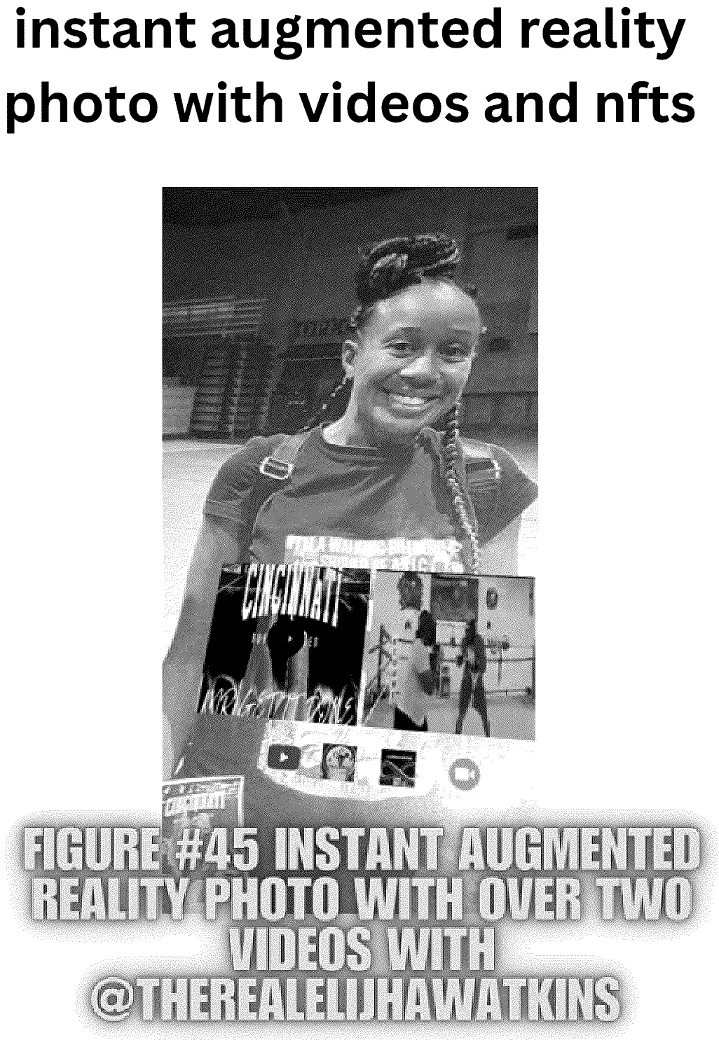

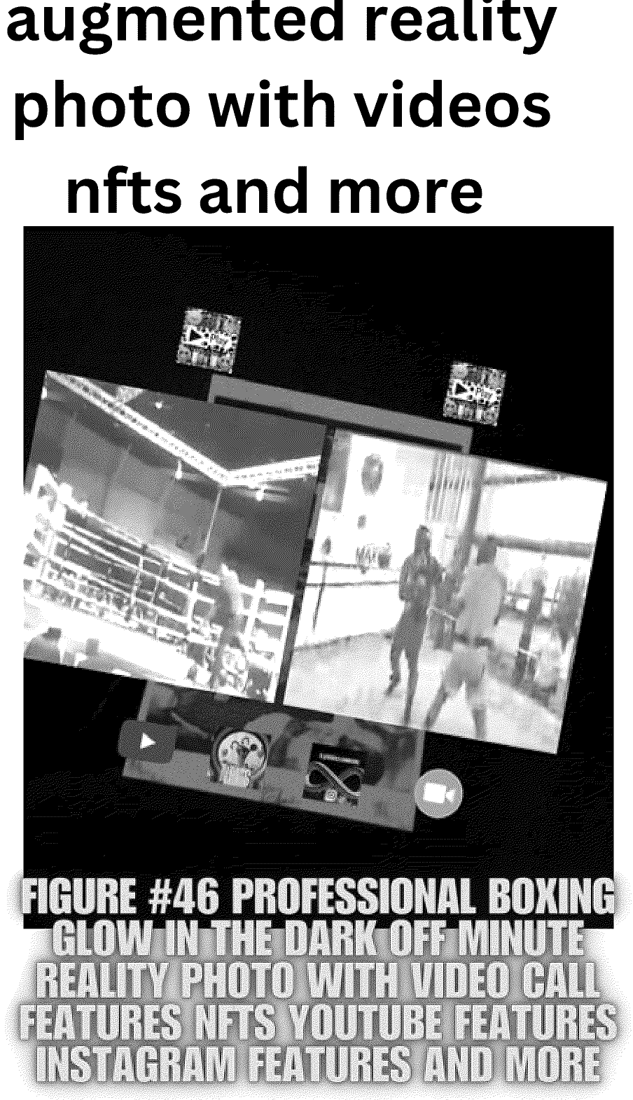

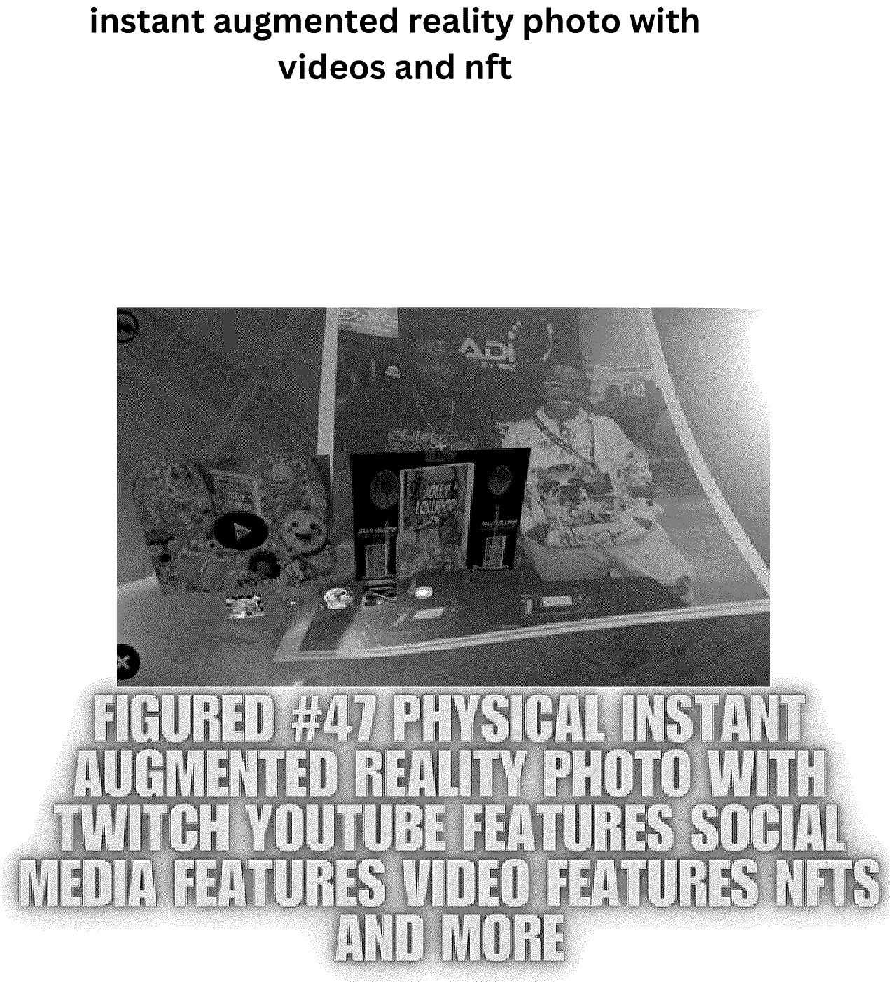

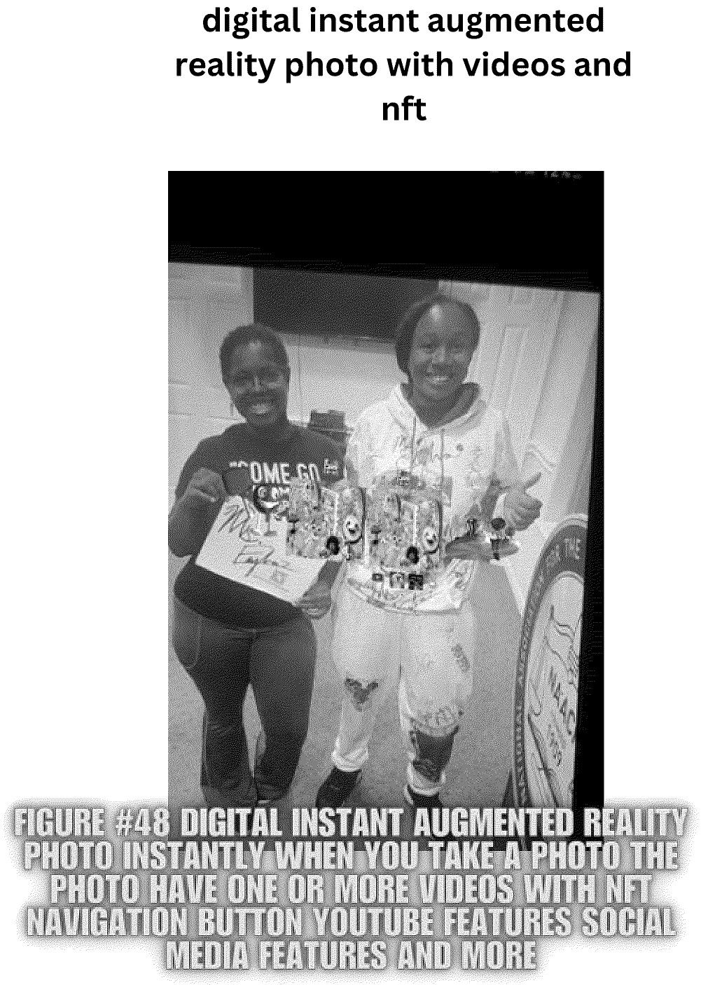

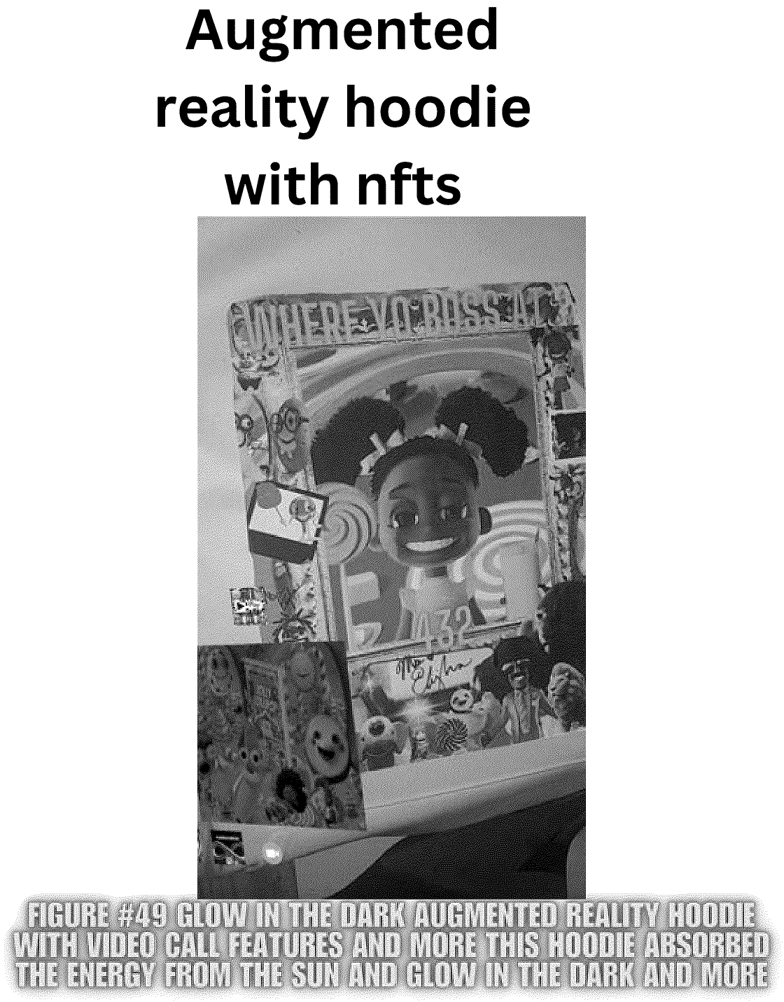

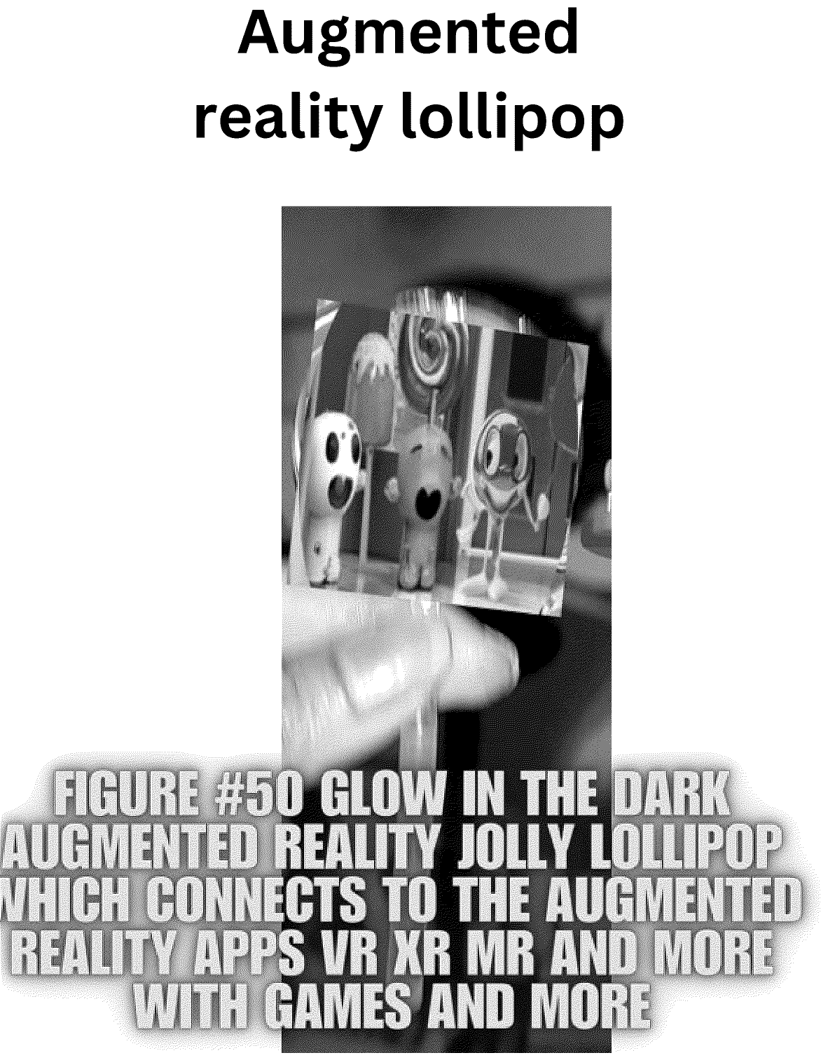

FIG. 3: Augmented Reality Pet Tag System, comprising:
Physical pet tags encoded with biometric data and identity information of the original owner.
Augmented reality features including videos of the original owner, video calling, NFTs, e-commerce store features, games, and more.
Encryption for securing the pet tag's content and identity information.
Integration with online and offline experiences for pet owners.

1. Biometric Handwritten Augmented Reality Autograph/Signature Stamp System, comprising:
A physical paper autograph encoded with biometric data and identity information.
Augmented reality features including videos, NFTs, e-commerce store features, games, and more.
Encryption for securing the autograph's content and identity information.
Integration with online and offline experiences.
A stamp associated with the original person only for verification purposes.

2. Instant Augmented Reality Photo System, comprising:
Physical and tangible products such as books, puzzles, and apparel.
Augmented reality features including videos, NFTs, e-commerce store features, games, and video calling.
Encryption for securing the photo's content.
Integration with the Web3 domain for ownership and control of NFTs.

3. Augmented Reality Pet Tag System, comprising:
Physical pet tags encoded with biometric data and identity information of the original owner.
Augmented reality features including videos of the original owner, video calling, NFTs, e-commerce store features, games, and more.
Encryption for securing the pet tag's content and identity information.
Integration with online and offline experiences for pet owners.
